(19) United States
(12) Patent Application Publication
(10) Pub. No.: US 2024/0005270 A1
(43) Pub. Date: Jan. 4, 2024

(54) INCREASING THE CAPACITY OF DIFFERENT TYPES OF PRODUCTS AND MATCHING STOCK WITH FORECASTED SALES VOLUMES PER PRODUCT TYPE IN AUTOMATIC VENDING MACHINES

(71) Applicant: PRINTEC BULGARIA JSC, Sofia (BG)

(72) Inventor: Svetoslav Dimov Paskalev, Shumen (BG)

(73) Assignee: PRINTEC BULGARIA JSC, Sofia (BG)

(21) Appl. No.: 17/856,967

(22) Filed: Jul. 2, 2022

(51) Int. Cl. G06Q 10/08; G07F 11/24

(52) U.S. Cl. CPC G06Q 10/087; G07F 11/24

(57) ABSTRACT

A system and a methodology are presented to solve the problem of increasing the capacity for different types of products, while matching stock with forecasted sales volumes per product type in automatic vending machines. The position of a selected product in a sub-shelf is calculated and tracked in a product stack. All products in the product stack, up to and including the selected product, are removed from the stack while maintaining their relative order in the stack. The selected product is then dispensed or discarded and the remaining removed products are returned to the stack while maintaining their relative order in the stack.

### BACKGROUND

### Field

The present invention relates to a system and method for increasing the capacity for different types of products and for matching stock with forecasted sales volumes per product type in automatic vending machines.

### Background

Automatic vending machines are very popular machines for selling a wide variety of products 24/7 without the need for a human seller to be present. The first modern vending machines were postcard vending machines, developed in England in the early 1880s. Today, vending machines are very popular in public spaces and offices and are used for selling food, beverage, or more specialized products like medicines or hardware parts. They are available in a wide variety of types, with specialized features (e.g. those selling medicaments). The common elements of virtually all vending machines are a storage area for the products to be dispensed, a product selection mechanism for selecting the desired product, a product picking module for conveying the selected product from the storage area to a dispenser area where the client can collect it, and a payment module where the client pays for the selected product prior to its placement to the pick-up (i.e. dispenser) area.

Typically, the storage area has the form of a rack and shelf assembly, the product selection mechanism is in the form of a button or other graphical or physical User Interface (UI), the picking module may be in the form of a screw holding and pushing to release the selected product or a robotic mechanism to place the selected product to the dispenser area, typically a cavity or container at the frontal side of the machine, and the payment module is either a coin, banknote, or credit card module capable of receiving payment, verifying it, and allowing the release of the selected product. The operation of modern vending machines is typically done by a microcontroller which controls the operation of the electromechanical modules and components of the machine.

Specialized vending machines are adapted to the specific types of products they sell (e.g. mechanical parts and accessories for bikes, etc.), and/to the specific vending procedures necessary for special products, like the regulated sale of medicaments. For example, the sale of medicaments requires the scanning of a medical prescription, its transmission to a remote, trained pharmacist who supervises the operation and validates the respective products (e.g. the products are scanned by the machine and the pharmacist verifies that they match those in the prescription and have not expired), and the products are labelled and dispensed to the user of the vending machine.

Known automatic vending machines, typically have a storage area in the form of a reconfigurable rack and shelf assembly to match the sizes of the products available for sale, whether sold by the package or by volume or weight. Typically, each shelf is reconfigurably divided in sub-shelves, each holding a single type of product sold in identical packages.

So, for example a shelf divided into 5 sub-shelves can hold, at max, 5 types of products, where each sub-shelve can hold a certain number of identical packets of the same product type, and this number depends on the dimensions of the packets relative to the dimensions of the sub-shelf. Assuming, for reasons of simplicity of our example, that each sub-shelf can hold 10 identical packets of the same product type, a vending machine with 5 shelves can stock and sell:

(5 shelves×5 sub-shelves)=25 product types

for a total of:

(25 product types×10 products per product type)=250 products

This arrangement limits the number of different product types on stock and sale to 25, since this is the maximum number of sub-shelves that can be used in this exemplary vending machine. So, other fast selling product types cannot be stocked and potential sales are lost.

Such an arrangement implies that for the vending machine to operate efficiently, all product types sell at the same rate, otherwise some products may run out long before others and require frequent restocking, resulting in increased cost for restocking and high risk of lost sales.

As the above hypothesis is usually not valid, it is customary to use more than one sub-shelf for each of the faster vending product types. So, for example, instead of 25 product types, a vending machine may be stocked as follows:

5 sub-shelves for Product A=5×10 product packages=50 Product A Packages

5 sub-shelves for Product B=5×10 product packages=50 Product B Packages

3 sub-shelves for Product C=3×10 product packages=30 Product C Packages

3 sub-shelves for Product D=3×10 product packages=30 Product D Packages

2 sub-shelves for Product E=2×10 product packages=20 Product E Packages

2 sub-shelves for Product F=2×10 product packages=20 Product F Packages

2 sub-shelves for Product G=2×10 product packages=20 Product G Packages

1 sub-shelf for Product H=1×10 product packages=10 Product H Packages

1 sub-shelf for Product I=1×10 product packages=10 Product I Packages

1 sub-shelf for Product J=1×10 product packages=10 Product J Packages

resulting in the vending machine stocking and selling 10 product types. Such a stocking strategy may be closer to the actual sale rates for the respective products, but it is not very efficient. One may consider that it is very likely that Product A may sell only 41 products, Product G only 17 products, product J only 4 products, etc. until the next refill of the vending machine. At the same time Product E may sell 20 products, and product I may sell 10 products and not any more because no more products E and I are in stock in the vending machine.

The above example indicates that planning the stocking of vending machines by utilizing a strategy like the one above is not very efficient and results in lost sales, client inconvenience, or increased costs for frequent restocking.

There is a clear need for a system and method that solves the problem of how to increase the capacity for different types of products, while matching stock with forecasted sales volumes per product type in automatic vending machines.

### SUMMARY

The present innovative solution solves the problem of increasing the capacity for different types of products, while matching stock with forecasted sales volumes per product type in automatic vending machines. The innovative solution solves the problems by proving a system and a methodology for stocking products of different types and/or dimensions in the same stack stored in the same storage location (e.g. in a sub-shelf at a shelf inside the vending machine) and for retrieving products from any position in the stack.

In a first exemplary embodiment, the interior of the vending machine houses a modular storage module with reconfigurable shelves and shelf partitions arranged inclined from the front face of the vending machine towards its interior, jointly forming at least one product holder in each shelf, where a product stop member holds a unitary width stack of products (of the same or of different types and dimensions) in the at least one product holder, in contact with the product stop element. Products loaded in the stack are recorded in a product log, containing the product code (used to identify the product), the product dimensions (used to calculate the exact physical storage location of the product when stored on the sub-shelf), the product expiry date, and the product location (as it is transitioned/moved across the various modules of the vending machine). After the user selects a product to buy (and makes the corresponding payment), a movable product picking module is aligned with the sub-shelf storing the selected product, and a product picking member at the end of the product picking module is actuated to push the first product of the stack of products (which is in contact with the product stop member) until the first product overcomes the product stop member and topples over a conveyor module on the top of the product picking module. After the first product is removed from the stack, its empty position in the stack is filled by the (next) second product as the entire stack slides down the sub-shelf until the second product touches the product stop element at the lower end of the sub-shelf. If the user has selected a product that is not the first product in the stack, the picking operation is repeated until the all products up to and including the desired product have been picked from the stack and have toppled over the conveyor module on the top of the product picking module. To ensure there is space and the order of the products on the conveyor module is not disturbed, the conveyor module is rotated after each new product has toppled over it so as to make space for the next product to topple. When the desired product is toppled onto the conveyor module, it is identified and verified and then placed at a dispenser area for the client to collect it. If the product is not identified or verified, it is dropped at a product dispose module for recycling, disposal, or restocking. The product log is updated after every operation and after a product is moved across any module of the vending machine.

In a second exemplary embodiment, the conveyor module is also rotated to push all products on its surface against a stop barrier 543 ensuring that more space can be made by more compactly and orderly stacking products on the conveyor module, and also that no product can fall off the conveyor module.

In a third exemplary embodiment, the selected product is moved from the conveyor module of the product picking module to an intermediate storage module, where it is identified and/or verified, before being moved to the dispenser area or the product dispose module.

In a fourth exemplary embodiment, the products are stored at reconfigurable sub-shelves formed onto shelves, using shelf partitions, arranged inclined from the posterior face of the vending machine towards its interior.

In a fifth exemplary embodiment, the products are stored at reconfigurable sub-shelves formed onto shelves, using shelf partitions, arranged inclined either from the frontal or the posterior faces of the vending machine towards its interior.

The system runs software to implement a method along the lines described above for the system's hardware components.

In sixth exemplary embodiment, the movable product picking module has a loading platform with two perpendicular bordering sides onto two opposing edges of the loading platform. The other opposing edges of the loading platform, are open and one of these open edges has a product picking member, securely attached to and leveled with the top surface of the loading platform and extending outwards of the platform, intended to pick the product of the stack of products in a sub-shelf that is in contact with a product stop element at the lower end of the inclined sub-shelf. The loading platform has a slot along its length through which an unloading member protrudes above the top surface of the loading platform and can move along the axis joining the two open edges of the loading platform. The product picking member is inclined longitudinally at about the longitudinal inclination of the sub-shelf, so as to allow the product picking module to form a ramp with the sub-shelf when aligned.

To remove the first product of a stack (i.e. the product that is in contact with the product stop member at the lower end of the corresponding inclined sub-shelf) the loading platform is moved towards the sub-shelf and until its longitudinal axis (i.e. the axis joining the two open edges of the loading platform) is aligned with the longitudinal axis of the sub-self (i.e. the axis passing from the product stop member and running along the shelf and the stacked products). This way the product picking member is aligned with a slot running longitudinally along the sub-shelf, and is dimensioned to movable fit inside the slot.

Initially, the loading platform is positioned so that its product picking member is aligned with the sub-shelf slot, lower than the lower surface of the sub-shelf. Then the loading platform is moved towards the sub-shelf until the product picking member is positioned underneath the first product in the sub-shelf's stack. Then the loading platform is raised until the product picking member has passed through the sub-shelf's longitudinal slot and pushed the first product upwards. Under the effect of the upward push received by the product picking member, the first product is lifted until it overcomes the product stop member of the inclined sub-shelf and topples onto the inclined loading platform under the influence of gravity. Once it has toppled, the first product starts sliding down the inclined loading platform until it touches the unloading member. At the same time, or immediately afterwards, the loading platform is lowered until the product picking member is located below the lower surface of the sub-shelf. Since the position previously occupied by the first product on the sub-shelf is empty, and since the product picking member is now below the lower surface of the sub-shelf, the second product (and all other products in the product stack) slide(s) down the inclined sub-shelf until it touches the product stop member. The process may be repeated until the desired product in the stack (e.g. the third product) is loaded onto the loading platform, or until the desired number of products are loaded on the loading platform (in the case where the customer has ordered more than one items of the same type). The unloading member may be positioned at any positioned along the longitudinal axis of the loading platform. For maximum capacity when loading the loading platform, the unloading member may be positioned at the position farthest from the product picking member. The two bordering sides (together with the unloading member) ensure that the product(s) loaded onto the loading platform will not fall off the loading platform.

To unload the product, that is closer to the product picking member, from the loading platform to the dispenser area for the client to pick it up, or to a sub-shelf during product rearrangement (e.g. when the client has been provided with the third product of a stack of products, and the first and second products that were unloaded from the same stack before the third product are repositioned back in the stack) a similar process is used like the process used for moving a product from the stack onto the loading platform.

Initially, the loading platform is positioned so that its product picking member is aligned over the dispenser area, and then the unloading member moves along the loading platform towards the product picking member, effectively pushing the product that is nearer the product picking member off the loading platform and into the dispenser area.

Once the product is dispensed, the loading platform is positioned so that its product picking member is aligned with the sub-shelf slot where the products were previously unloaded from. The product picking member is aligned higher than the product stop member of the sub-shelf. Then the loading platform is moved towards the sub-shelf until the product picking member is positioned in front of the product in the sub-shelf's stack that rests on the product stop member. Then the unloading member moves along the loading platform towards the product picking member, effectively pushing the products from the loading platform towards the sub-shelf, where they start pushing the product that was resting on the product stop member, which starts to slide uphill the sub-shelf. The unloading member moves along the loading platform towards the product picking member until all products from the loading platform have been pushed past the product stop member, and have fallen on the upper surface of the sub-shelf under the influence of gravity.

The unloading member then moves along the loading platform away from the product picking member (i.e. retracts), allowing the product in the products stack of the sub-shelf to slide, under the influence of gravity, until they reach the product stop member. The loading platform can then rest or be realigned with another sub-shelf.

The same processes can be used for restocking the vending machine using a restocking self or rack of selves (e.g. one that can be loaded to and unloaded from the vending machine much like inserting or removing a cartridge. Such an operation can significantly reduce stocking time and minimize or eliminate manual operations to be performed by a human operator, thus slushing costs.

During the above operations, the vending machine tracks and logs the position and movement of products, their dimensions, and relative positions in stacks, using sensors, so as to ensure that only the desired products will be dispensed, discarded, restocked, or restacked and that their order and orientation in the product stacks is always known.

### BRIEF DESCRIPTION OF THE DRAWINGS

FIG. 1 shows a simplified, behind the cover, frontal view of an automatic vending machine.

FIG. 2 shows a simplified, behind the cover, side view of an automatic vending machine.

FIG. 3A shows a simplified side view, along the longitudinal axis, of an exemplary product picking module.

FIG. 3B shows a simplified top-down view of the exemplary product picking module of FIG. 3A.

FIG. 4A shows a simplified side view, along the longitudinal axis, of an exemplary product picking module positioned for picking a selected product from a sub-shelf.

FIG. 4B shows the picking of the selected product by the product picking module according to FIG. 4A.

FIG. 4C shows the loading of the selected product onto the product picking module according to FIG. 4B.

FIG. 4D shows the alignment of the product picking module, according to FIG. 4C, with the intermediate storage module.

FIG. 4E shows the transfer of the selected product from the product picking module, according to FIG. 4D, to the intermediate storage module.

FIG. 4F shows the selected product, according to FIG. 4E, on the intermediate storage module.

FIG. 4G shows the transfer of the selected product from the intermediate storage module, according to FIG. 4F, to the dispenser area.

FIG. 4H shows the transfer of the selected product from the intermediate storage module, according to FIG. 4G, to the product dispose module.

FIG. 5A shows a simplified side view, along the longitudinal axis, of an exemplary product picking module according to the present invention, positioned for picking a selected product from a sub-shelf.

FIG. 5B shows the picking of a first product by the product picking module according to FIG. 5A.

FIG. 5C shows the loading of the first product onto the product picking module according to FIG. 5B.

FIG. 5D shows the picking of the second product onto the product picking module according to FIG. 5C.

FIG. 5E shows the loading of the second product onto the product picking module according to FIG. 5D.

FIG. 5F shows the movement of the second product along the product picking module according to FIG. 5E.

FIG. 5G shows the picking of the third product onto the product picking module according to FIG. 5F.

FIG. 5H shows the loading of the third product onto the product picking module according to FIG. 5G.

FIG. 5I shows the alignment and the transfer of the third product from the product picking module, according to FIG. 5H, to the dispenser area.

FIG. 5J shows the transfer of the third product from the product picking module, according to FIG. 5H, to the product dispose module.

FIG. 5K shows the loading of the second product from the product picking module to its sub-shelf, according to FIG. 5J.

FIG. 5L shows the completion of the loading of the second product from the product picking module to its sub-shelf, according to FIG. 5K.

FIG. 5M shows the loading of the first product from the product picking module to its sub-shelf, according to FIG. 5M.

FIG. 5N shows the completion of the loading of the first product from the product picking module to its sub-shelf, according to FIG. 5M.

FIG. 6 shows a high-level flow diagram of an exemplary methodology for the operation of the automatic vending machine of the present invention.

FIG. 7A shows an exemplary high-level system electronics architecture diagram of the automatic vending machine of the present invention.

FIG. 7B shows an exemplary high-level electronics architecture of the controller of the automatic vending machine of the present invention.

FIG. 8 shows an exemplary high-level software architecture diagram of the automatic vending machine of the present invention.

FIG. 9 shows a simplified, behind the cover, side view of an automatic vending machine using the product picking module of the sixth exemplary embodiment.

FIG. 10A shows a simplified side view, along the longitudinal axis, of the product picking module of the sixth exemplary embodiment.

FIG. 10B shows a simplified top-down view of the exemplary product picking module of FIG. 10A.

FIG. 11A shows a simplified side view, along the longitudinal axis, of the product picking module of the sixth exemplary embodiment, aligned with the sub-shelf for picking a selected product.

FIG. 11B shows a simplified side view, along the longitudinal axis, of the product picking module of the sixth exemplary embodiment, with its product picking member under the first product of the stack.

FIG. 11C shows a simplified side view, along the longitudinal axis, of the product picking module of the sixth exemplary embodiment, with its product picking member toppling the first product from the stack.

FIG. 11D shows a simplified side view, along the longitudinal axis, of the product picking module of the sixth exemplary embodiment, after it has loaded the first product.

FIG. 11E shows a simplified side view, along the longitudinal axis, of the product picking module of the sixth exemplary embodiment, with its product picking member under the second product of the stack.

FIG. 11F shows a simplified side view, along the longitudinal axis, of the product picking module of the sixth exemplary embodiment, with its product picking member toppling the second product from the stack.

FIG. 11G shows a simplified side view, along the longitudinal axis, of the product picking module of the sixth exemplary embodiment, after it has loaded the second product.

FIG. 11H shows a simplified side view, along the longitudinal axis, of the product picking module of the sixth exemplary embodiment, after it has loaded the second product and lowered its product picking member below the sub-shelf.

FIG. 12A shows a simplified side view, along the longitudinal axis, of the product picking module of the sixth exemplary embodiment, after it has loaded the second product and is moving away from the sub-shelf.

FIG. 12B shows a simplified side view, along the longitudinal axis, of the product picking module of the sixth exemplary embodiment, after it has loaded the second product and is being aligned with another sub-shelf.

FIG. 12C shows a simplified side view, along the longitudinal axis, of the product picking module of the sixth exemplary embodiment, after it has aligned with the other sub-shelf and its product picking member is over the product stop element of the other sub-shelf.

FIG. 12D shows a simplified side view, along the longitudinal axis, of the product picking module of the sixth exemplary embodiment, after its product picking member is positioned over the product stop element of the other sub-shelf, and the product unloading member pushes the loaded products from the product loading platform towards the other sub-shelf.

FIG. 12E shows a simplified side view, along the longitudinal axis, of the product picking module of the sixth exemplary embodiment, with its product unloading member pushing second loaded product 424 (via first loaded product 423) from the product loading platform onto the other sub-shelf, which second product 424, in turn, pushes fifth product 428, which slides uphill the sub-shelf.

FIG. 12F shows a simplified side view, along the longitudinal axis, of the product picking module of the sixth exemplary embodiment, after the second product has been stacked onto the other sub-self.

FIG. 13A shows a simplified side view, along the longitudinal axis, of the product picking module of the sixth exemplary embodiment, after it has been positioned over the dispensing area.

FIG. 13B shows a simplified side view, along the longitudinal axis, of the product picking module of the sixth exemplary embodiment, after it has been positioned over the dispensing area, and while the product unloading member pushes the loaded products off the product loading platform.

FIG. 13C shows a simplified side view, along the longitudinal axis, of the product picking module of the sixth exemplary embodiment, after its product unloading member has pushed the second loaded product off the product loading platform.

FIG. 13D shows a simplified side view, along the longitudinal axis, of the product picking module of the sixth exemplary embodiment, after the second loaded product is being picked up by the customer from inside the dispensing area.

### DETAILED DESCRIPTION

Any embodiment described herein as “exemplary” is not necessarily to be construed as preferred or advantageous over other embodiments.

The term “exemplary” is used herein to mean “serving as an example, instance, or illustration”.

The acronym “ASIC” is intended to mean “Application-Specific Integrated Circuit”.

The acronym “CD” is intended to mean “Compact Disc”.

The acronym “DSL” is intended to mean “Digital Subscriber Line”.

The acronym “DVD” is intended to mean “Digital Versatile Disc”.

The acronym “GUI” is intended to mean “Graphical User Interface”.

The acronym “IR” is intended to mean “Infra Red”.

The acronym “LED” is intended to mean “Light Emitting Diode”.

The acronym “QR” is intended to mean “Quick Response”.

The acronym “S/W” is intended to mean “Software”.

The acronym “XML” is intended to mean “eXtensible Markup Language”.

The term “mobile device” may be used interchangeably with “client device” and “portable device with wireless capabilities”.

The term “user” may be used interchangeably with “regular user”, “ordinary user”, “customer” and “client”. It may also be used to mean “user of an application” or “user of a service”. It may also be used to refer to a “patient using a device, application, or service”, or to a “client using a device, application, or service”, unless otherwise explicitly stated or implicitly hinted at in the description, or obvious to a reader of ordinary skill in related art that these terms refer to different things, as this is apparent by the context of the discussion in which they appear.

The term “pharmacist” may be used interchangeably with “doctor”, “physician”, “pharmacy operator” and the like.

The term “system” may be used interchangeably with “device”, “computing device”, “apparatus”, “computing apparatus”, and “service”, except where it is obvious to a reader of ordinary skill in related art that these terms refer to different things, as this is apparent by the context of the discussion in which they appear. Under any circumstance, and unless otherwise explicitly stated or implicitly hinted at in the description, these six terms should be considered to have the broadest meaning i.e. that of encompassing all six.

The term “module” may be used interchangeably with “sub-module”, “unit” or “subunit”, except where it is obvious to a reader of ordinary skill in related art that these terms refer to different things, as this is apparent by the context of the discussion in which they appear.

The term “product” may be used interchangeably with “loaded product”, and “stacked product”, except where it is obvious to a reader of ordinary skill in related art that these terms refer to different things, as this is apparent by the context of the discussion in which they appear.

The term “product” may be omitted in the various technical terms. It is assumed to be implied unless it is obvious to a reader of ordinary skill in related art that its omission is purposeful, as this is apparent by the context of the discussion in which it appears.

The term “member” may be used interchangeably with “module”, except where it is obvious to a reader of ordinary skill in related art that these terms refer to different things, as this is apparent by the context of the discussion in which they appear.

The term “pick” may be used interchangeably with “load”, except where it is obvious to a reader of ordinary skill in related art that these terms refer to different things, as this is apparent by the context of the discussion in which they appear.

The term “means for unloading products” is intended to mean both “product unloading member” and “product picking member”, depending on the context of the discussion.

The term “dispenser area” may be used interchangeably with “dispenser module”, except where it is obvious to a reader of ordinary skill in related art that these terms refer to different things, as this is apparent by the context of the discussion in which they appear.

The term “disposal area” may be used interchangeably with “disposal module”, except where it is obvious to a reader of ordinary skill in related art that these terms refer to different things, as this is apparent by the context of the discussion in which they appear.

An Exemplary Automatic Vending Machine According to the Present Innovative Solution

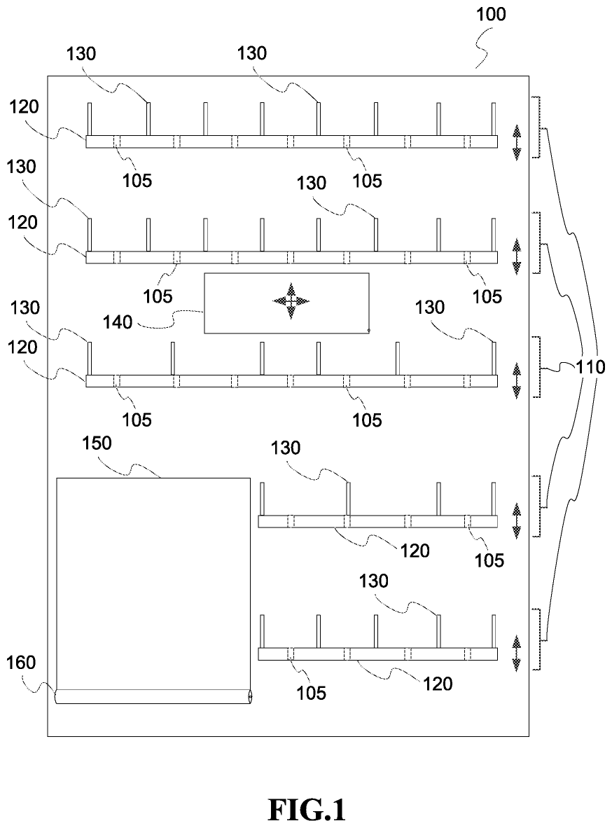

FIG. 1 shows a simplified, behind the cover, frontal view of an automatic vending machine. Vending Machine 100 has a modular storage system 110 in the form of a rack where shelves 120 are mounted one above the other. These shelves can be positioned at various heights on the rack, relative to each other, so as to accommodate the size of the products they are intended to hold. Each shelf can be partitioned into two or more sub-shelves by means of partitions 130 which can be attached on the shelf. Both the shelves and the partitions are attached at holes, indentations, or similar holding features formed on the rack and the shelved, respectively. Shelves 120 have gaps 105 running along their width (i.e. perpendicular to the longitudinal axis running along the width of the face of vending machine 100).

A product picking module 140 is also provided, which is designed to pick a product from its storage position on a sub-shelf and hold on top of the module 140. The product picking module 140 may have any form, like a platform (or main body) with a top surface for receiving the picked product, or a box-like structure with at least the top and a side open for receiving and holding the picked product, and the like. The product picking module 140 is designed to be movable in the x, y and, optionally, the z axes, so that it can be moved and aligned with a sub-shelf for picking a product. The product picking module 140 then moves and aligns with a dispenser area 150, arranged to be accessed from the outside of vending machine 100, and the picked product is moved from the product picking module 140 to the dispenser area 150 where the client can collect the product.

Optionally dispenser area 150 has a dispenser conveyor 160, which forms the bottom surface of dispenser area 150 and which, optionally, protrudes outside dispenser area 150 and away from the outside of vending machine 100 where the dispenser area 150 is connected. When the dispenser conveyor 160 is attached to dispenser area 150, product picking module 140 drops the picked product onto dispenser conveyor 160, which is then actuated to move the picked product inside the dispenser area 150 for the user to collect the product.

When dispenser conveyor 160 is not used, dispenser area 150 is dimensioned to extend from the outside of vending machine 100 toward the interior of vending machine 100, so that when product picking module 140 drops the picked product inside dispenser area 150, the client may collect it. In a modified exemplary embodiment, the picked product is guided toward the area of dispenser area 150 adjacent to the outside of vending machine 100 for easier collection, for example, by having dispenser area's 150 bottom structured like a ramp inclined downwards from the inside to the outside wall of vending machine 100, where dispenser area 150 is attached. For easier visualization, FIG. 1 does not illustrate the front cover of vending machine 100, which is formed to close vending machine 100 and has an opening positioned and dimensioned to allow dispenser area 150 to attached onto. Shelves 120 that are positioned at the same height as dispenser area 150 are dimensioned to a length that allows both shelves 120 and dispenser area 150 to fit side-by-side inside vending machine 100.

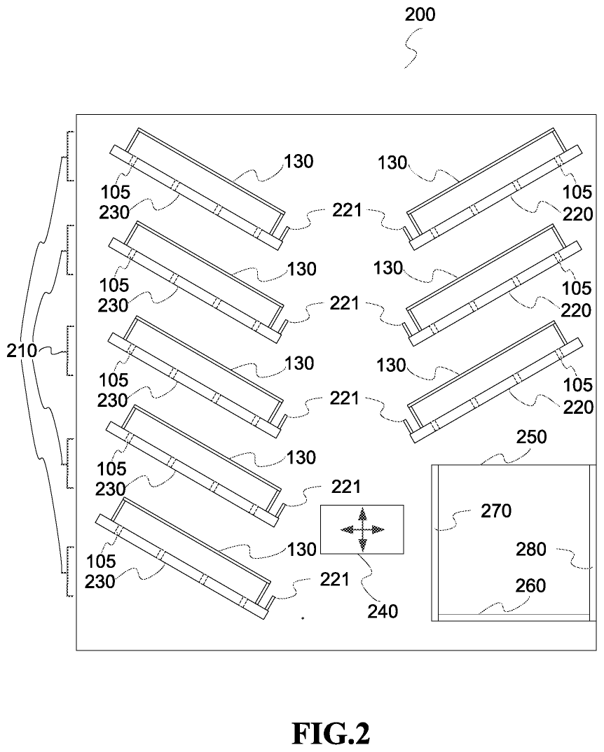

FIG. 2 shows a simplified, behind the cover, side view of an automatic vending machine. Vending machine 200 has a modular storage system 210 in the form of a rack with a movable set of shelves 220, arranged above each other, each aligned with the width of the frontal face of vending machine 200, and attached on a rack system (not shown). Shelves 220 are position at an angle to the horizontal so that each forms a ramp inclined towards the inside of the vending machine, and partitions 130 are movably attached on shelves 220 to partition them into sub-shelves.

At the lower end of each of sub-shelf of shelves 220 is attached a product stop member 221 (not shown in FIG. 1) which is intended to form a barrier preventing products from slipping off the respective sub-shelf. In one aspect product stop member 221 has a height, protruding over the top surface of the sub-shelf, that is chosen so as to provide enough support to the product it is in contact with, while at the same time allowing the product to overcome product stop member 221 and become free to fall off the sub-shelf once the product is almost totally or totally raised over the top of product stop member 221. Typically, the height of product stop member 221 is chosen between 10%-50% of the height of the product is in contact with, but other relative heights of product stop member 221 can be selected. In another aspect, an individual product stop member 221 is attached at the lower end of each sub-shelf, while in another aspect, a single product stop member 221 is used per shelf 220, thereby the same product stop member 221 is used across all sub-shelves of the same shelf.

Product picking module 240 is oriented horizontally (i.e. perpendicular to the vertical axis), is aligned with a sub-shelf of a shelf 220 and is used to pick the product in contact with product stop member 221 at the sub-shelf, and then drops the picked product to the dispenser area 250, or into the optional dispenser conveyor 260. Dispenser area 150 has two optional shutters an internal shutter 270 and an external shutter 280 (not shown in FIG. 1). External shutter 280 is always closed so as to prevent access from the outside to the inside of vending machine 200 and only opens for allowing clients to collect their selected product or products. Before opening external shutter 280, internal shutter 270 is closed so as to isolate dispenser area 250 from the inside of vending machine 200. Internal shutter 270 is opened only if external shutter 280 is closed, for allowing the movement of the picked product from product picking module 240 to dispenser area 250.

In an alternative exemplary embodiment, shelves 220 are replaced by shelves 230, which are aligned with the width of the posterior face of vending machine 200. In one aspect shelves 220 and 230 are identical, while in another aspect they differ. Shelves 230 operate identically or similarly to the operation of shelves 220 and allow the operation of product picking module 240 and dispenser area 250 as previously presented for shelves 220.

In yet another exemplary embodiment, both shelves 220, 230 are installed inside vending machine 200 for increasing the capacity of vending machine 200. In this exemplary embodiment, product picking module 240 and dispenser area 250 are designed to operate with both shelves 220, 230.

Shelves 220, 230 have gaps running along their width (i.e. perpendicular to the longitudinal axis running along the width of the face or back of vending machine 200).

An Exemplary Product Picking Module According to the Present Innovative Solution

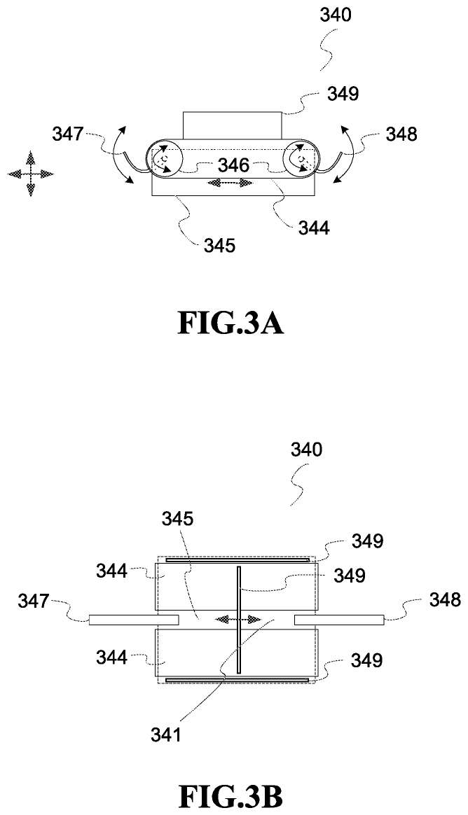

FIG. 3A shows a simplified side view, along the longitudinal axis, of an exemplary product picking module. Product picking module 340 has a main body 345 housing actuators (e.g. stepper motors). At the top face of product picking module 340 is attached a conveyor module 344, which is kept in place and rotated by means of two rollers 346 (or bearings, or similar elements), which are rotatably attached at two ends of the top face of product picking module 340 and controlled by an actuator. Conveyor module 344 is aligned to move products placed on it, towards the frontal or back faces of vending machine 100, 200.

Product picking module 340 is designed to movably attach on a frame installed inside vending machine 100, 200 for moving in the x, y, and optionally the z direction by using a positioning module (e.g. in its main body, or at the frame), that has 2 or 3 actuators, respectively. The frame onto which product picking module 340 moves in not shown in FIG. 3A.

Near the ends of product picking module 340, where rollers 346 are attached, are positioned a first rotating picking member 347, and a second rotating picking member 348, each connected with an actuator (e.g. a stepper motor). Both picking members 347, 348 are kept in disengaged position, whereby they are completely below, or at the same level, or below the top level of conveyor module 344. At its disengaged position, and when product picking module 240 is aligned with a sub-shelf of a shelf 220, picking member 348 is aligned (still at its disengaged position), underneath the product, with the gap running along the sub-shelf holding the product. The actuator connected with picking member 348 is actuated to rotate picking member 348 to its engaged position, which is above the top level of conveyor module 344.

Picking module 344 also has an optional barrier member 349, which is attached on picking module 344 so as to protrude above picking module 344 and prevents products that are loaded on conveyor module 344 from falling off of it. Barrier member 349 may be planar or otherwise shaped and attached perpendicularly or inclined to the upper surface of conveyor module 344.

In another aspect, at its disengaged position, and when product picking module 340 is aligned with a sub-shelf of a shelf 230, picking member 347 is aligned (still at its disengaged position), underneath the product, with the gap running along the sub-shelf holding the product. The actuator connected with picking member 347 is actuated to rotate picking member 347 to its engaged position, which is above the top level of conveyor module 344.

FIG. 3B shows a simplified top-down view of the exemplary product picking module of FIG. 3A. Product picking module 340 has main body 345, on which is attached a conveyor module 344, which has one long face over the surface of main body 345. In another aspect, conveyor module 344 is structured as two conveyor module members spaced by a gap or slot 341 along the longitudinal axis of product picking module 340. Product picking module 340 has a second 348 and an (optional) first 347 picking members which are rotatable between an unengaged and an engaged position as previously described. The design and actuation (via separate actuators or in another exemplary embodiment by the same actuator) of picking members 347, 348 is such that they do not obstruct or interfere with the operation of conveyor module 344. Product picking module 340 also has a barrier member 349 attached to main body 345, so that barrier member 349 extends over the upper surface of conveyor module 344. In one aspect, barrier member 349 is planar, while in another aspect it may have two or more members, which may also be movable.

Picking a Product from the First Position in a Stack of Products According to the Present Innovative Solution

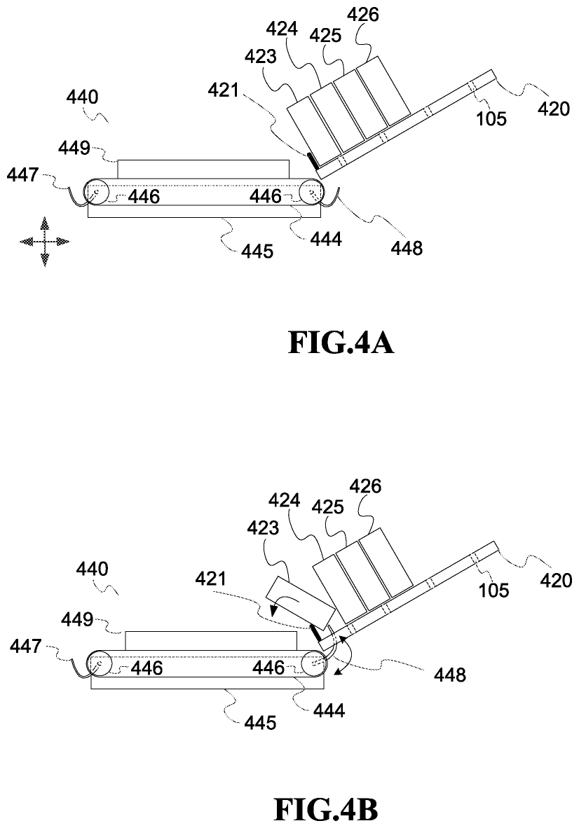

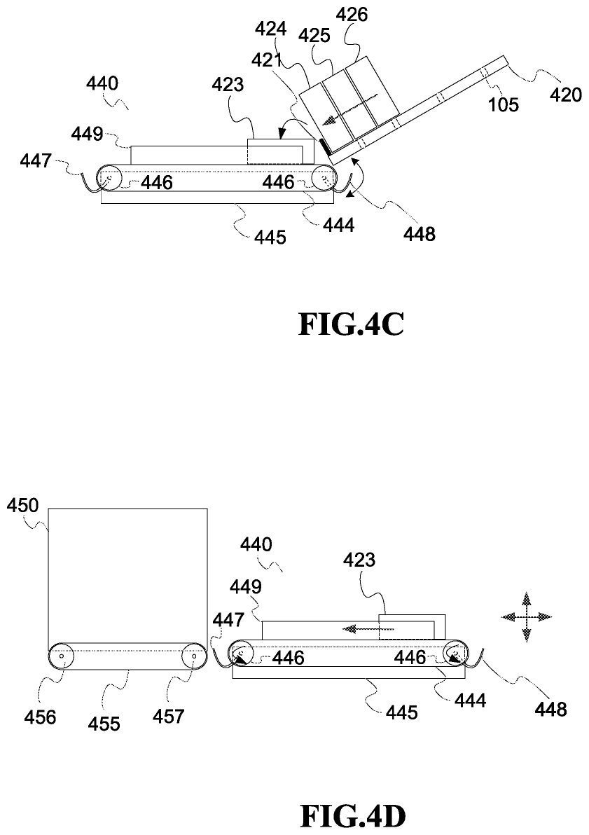

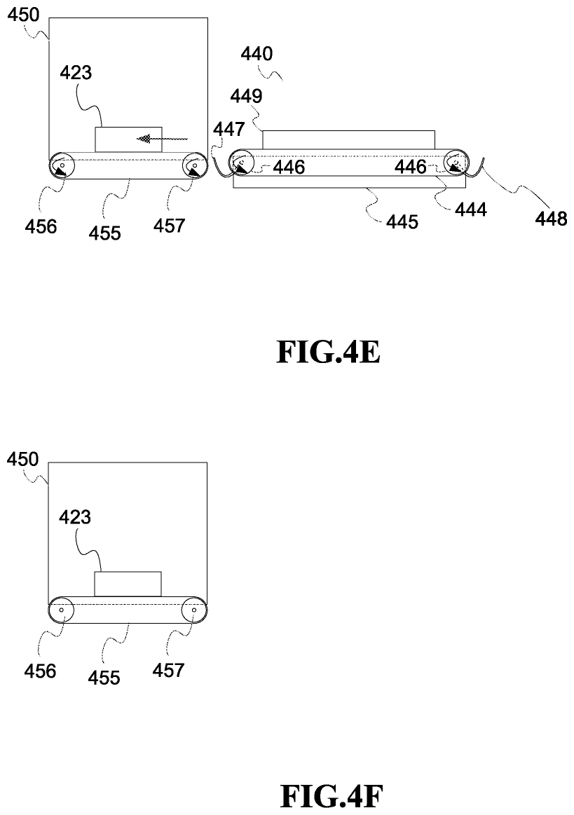

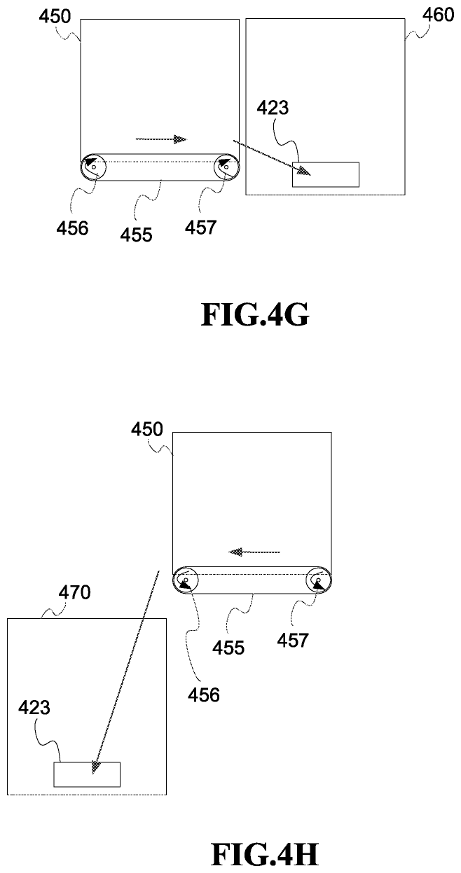

FIG. 4A shows a simplified side view, along the longitudinal axis, of an exemplary product picking module positioned for picking a selected product from a sub-shelf. Shelf 420 is attached on the rack inside the vending machine and a sub-shelf is formed on shelf 420, and equipped with a product stop member 421. The product stop member 421 holds a unitary-width stack of products in physical contact with each other (a first 423, a second, 424, a third 425, and a fourth 426 products—more products may be stacked but are not shown), where first product 423 is in physical contact with product stop member 421. Products 423-426 are of the same type and dimensions.

Product picking module 440 has a main body 445, a conveyor module 444 kept in place and rotated by means of two rollers 446 (or bearings or similar elements), a first rotating picking member 447, and a second rotating picking member 448, and an optional barrier member 449.

Product picking module 440 is aligned with the sub-shelf of shelf 420, where the desired product is held, so that the upper surface of conveyor module 444 is positioned leveled or under the lowest part of shelf 420 so that second rotating picking member 448 is aligned (still at its disengaged position), underneath the product, with the gap running along the sub-shelf holding the product.

In one aspect, product picking module 440 is of the type shown in FIG. 3A-B. In another aspect, product picking module 440 may have alternative forms.

FIG. 4B shows the picking of the selected product by the product picking module according to FIG. 4A. The actuator connected with picking member 448 is actuated to rotate picking member 448 to its engaged position, which is above the top level of conveyor module 444, and through the gap running along the sub-shelf holding the product. By rotating picking member 448 to its engaged position, picking member 448 pushes the bottom side of the first product 423 and lifts it over product stop member 421, so that first product 423 is now freed from stop member 421 and at the same time its position on the sub-shelf is left vacant and picking member 448 is actuated back to its disengaged position, thereby the products remaining on the sub-shelf slide all the way until product stop member 421. First product 423 topples towards product picking module 440 under the force exerted to it by the sliding products that remain on the sub-shelf.

FIG. 4C shows the loading of the selected product onto the product picking module according to FIG. 4B. Toppling first product 423 lands on conveyor module 444.

FIG. 4D shows the alignment of the product picking module, according to FIG. 4C, with the intermediate storage module. Product picking module 440 is then moved and aligned with optional intermediate storage module 450, also inside the vending machine (not shown in the previous figures). In one aspect, intermediate storage module 450 has an intermediate conveyor module 455 forming its bottom surface, which is kept in place and rotated by means of two rollers 456, 457 connected to an actuator. Intermediate conveyor module 455 is designed to load the product or products from product picking module 440 onto intermediate conveyor module 455, and to unload the products from intermediate conveyor module 455 for the client to collect them. Intermediate conveyor module 455 is designed to move products along an axis perpendicular to the frontal and back face of the vending machine.

FIG. 4E shows the transfer of the selected product from the product picking module, according to FIG. 4D, to the intermediate storage module. Conveyor module 444 is actuated in one direction to move first product 423 to intermediate conveyor module 455, effectively loading first product 423 from product picking module 440 onto intermediate conveyor module 455. This operation may optionally be aided by also actuating intermediate conveyor module 455 in one direction.

In the illustrated exemplary embodiment, product picking module 440 is shown arranged to the right of intermediate conveyor module 455. However, in another exemplary embodiment, the reverse relative positions may be used. Also, in another exemplary embodiment, product picking module 440 may align with another shelf, or with both shelf 420 and the other shelf, one at a time.

FIG. 4F shows the selected product, according to FIG. 4E, on the intermediate storage module. First product 423 is now loaded on intermediate storage module 450. At this point an optional verification of the loaded product or products may be made. For instance, a scanner (e.g. Infra-Red (IR), or a camera) may scan the loaded product(s)'s barcode, Quick Response (QR) code, label, etc. and use the scanned image to either automatically identify and verify the products and its details (e.g. size, expiry date, etc.) or send the scanned image to human operator for manual verification (e.g. for the sale of medicaments or other regulated products). One or more scanners may be used to scan one or more sides of the product for acquiring all the necessary information which may be positioned on more than one sides of the product.

In an alternative exemplary implementation, where no intermediate storage module 450 is used, the scanning may be done on the product picking module 440 where first product 423 is placed.

In yet another exemplary implementation, the scanning of first product 423 may be done both on the product picking module 440 and on intermediate storage module 450.

FIG. 4G shows the transfer of the selected product from the intermediate storage module, according to FIG. 4F, to the dispenser area. If the scanned product is verified and approved, first product 423 is moved from intermediate storage module 450 over to dispenser module 460 by actuating intermediate conveyor module 455 in one direction. The product can then be collected by the client.

FIG. 4H shows the transfer of the selected product from the intermediate storage module, according to FIG. 4G, to the product dispose module. If the scanned product is not verified or approved, first product 423 is transferred from intermediate storage module 450 over to product dispose module 470 by actuating intermediate conveyor module 455 in another direction. The product can then be collected by service staff for recycling, disposal, or restocking.

Product dispose module 470 is preferably placed below the level of the top surface of intermediate conveyor module 455. In another aspect, the bottom surface of product dispose module 470 is at the same level as the top surface of intermediate conveyor module 455.

Picking a Product from a Position in a Stack of Products of Multiple Types and/or Dimensions According to the Present Innovative Solution

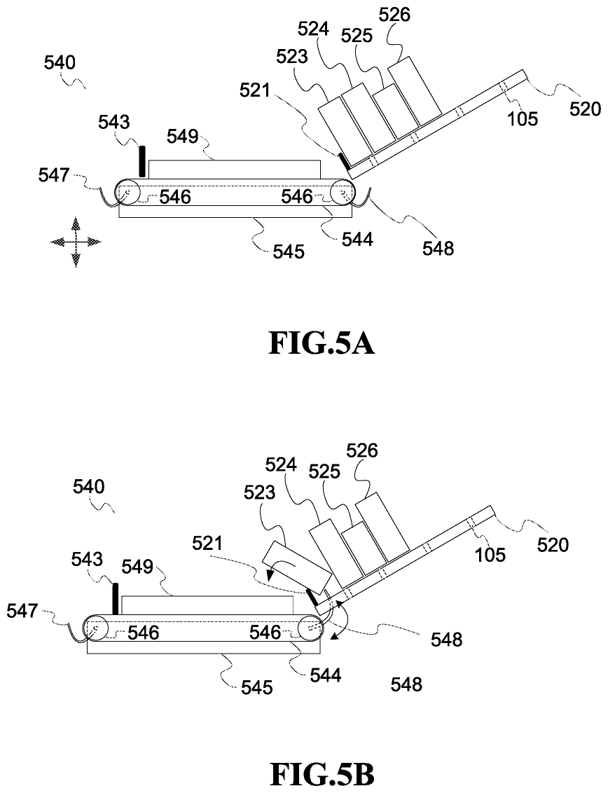

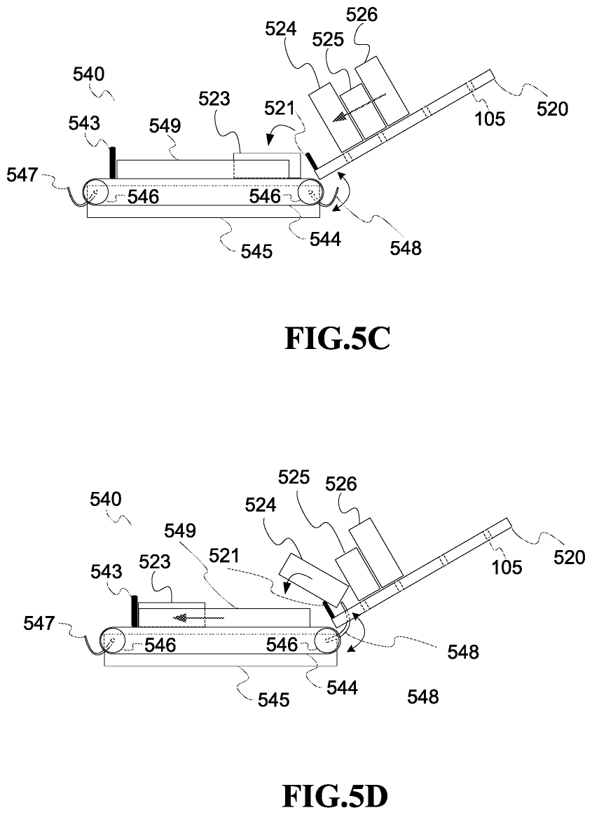

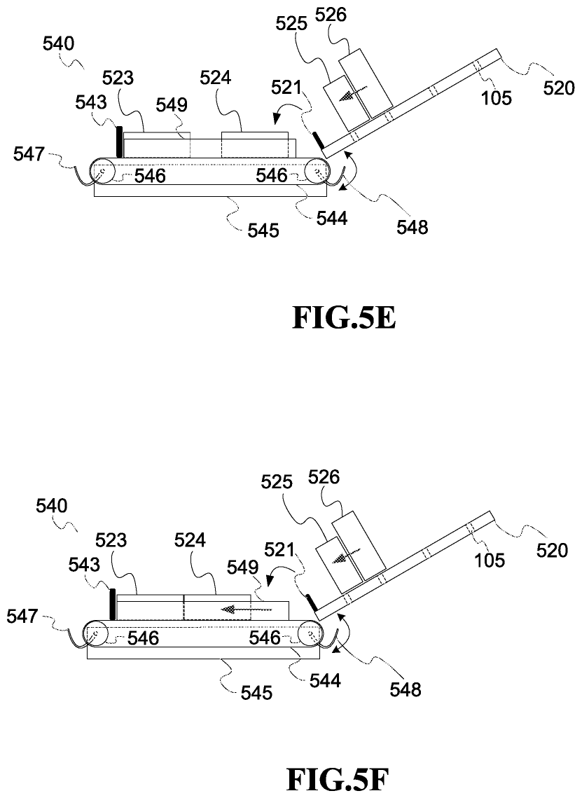

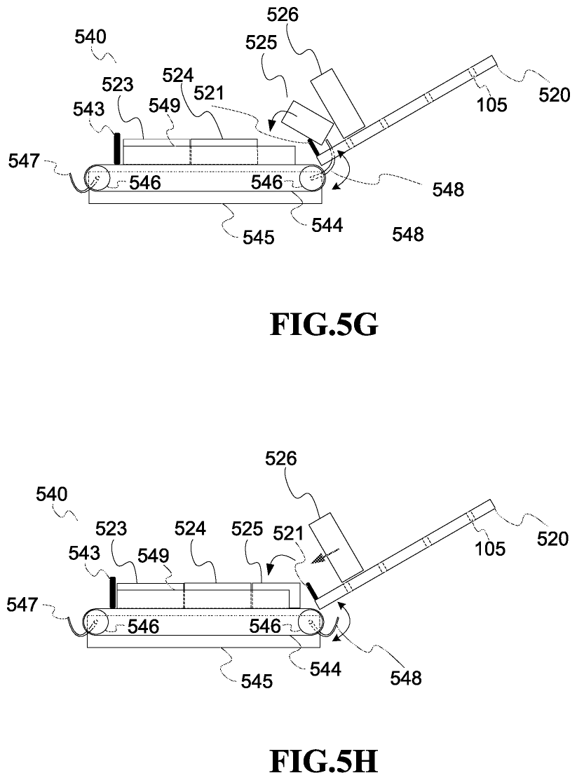

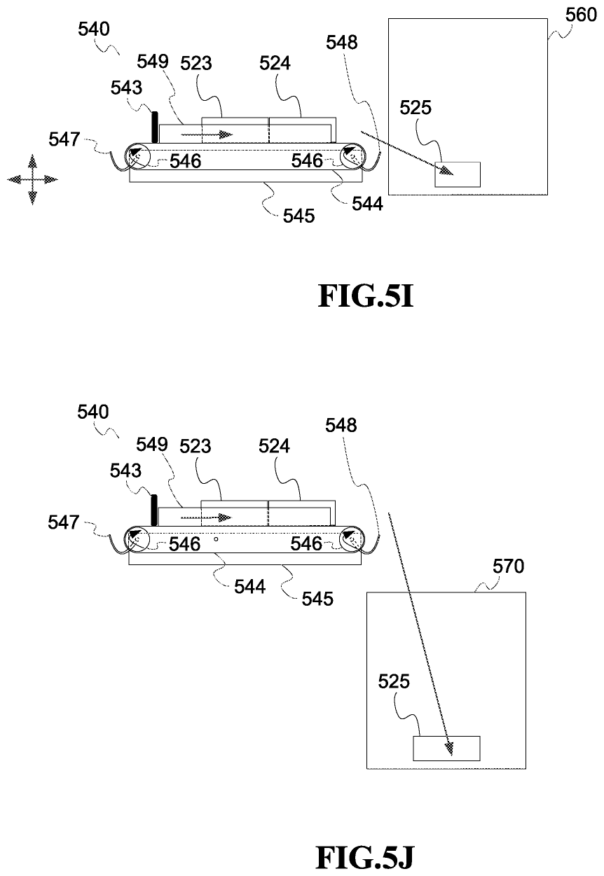

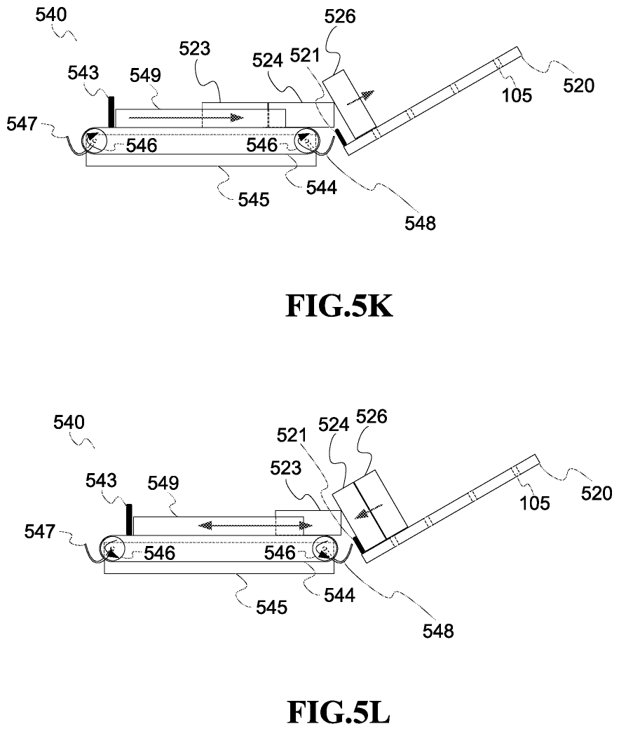

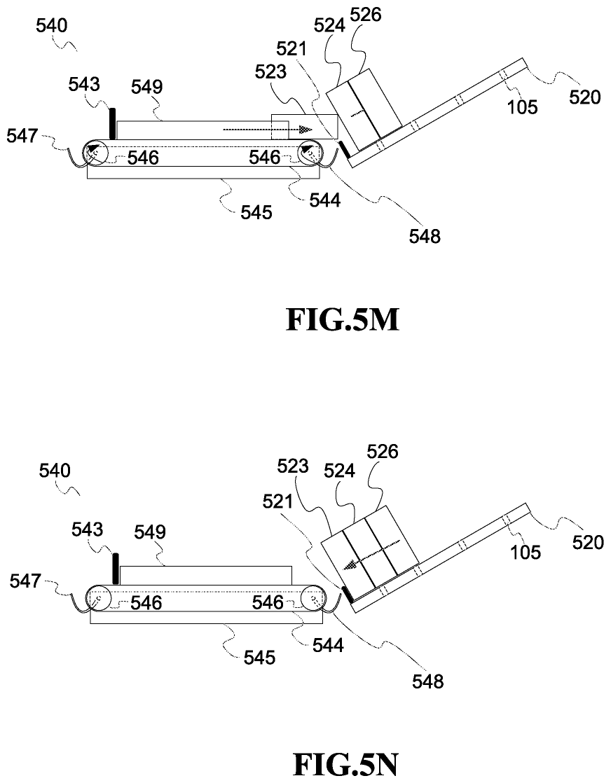

FIG. 5A shows a simplified side view, along the longitudinal axis, of an exemplary product picking module according to the present invention, positioned for picking a selected product from a sub-shelf holding multiple product types. Shelf 520 is attached on the rack inside the vending machine and a sub-shelf is formed on it, and equipped with a product stop member 521. Product stop member 521 holds, at the sub-shelf, a unitary-width (or multiple-width) stack of products of different types and/or dimensions, in physical contact with each other (a first 523, a second, 524, a third 525, and a fourth 526 products—more products may be stacked but are not shown), where first product 523 is in physical contact with product stop member 521. Products 523-526 are of different types and/or dimensions. The products may be stacked on any of their faces.

Product picking module 540 has a main body 545, a conveyor module 544 kept in place and rotated by means of two rollers 546 (or bearings or similar elements), a first rotating picking member 547, and a second rotating picking member 548, an optional barrier member 549, and an optional stop barrier 543. Conveyor module 544 is aligned so that it moves products placed on it, along an axis perpendicular to the frontal and back faces of vending machine 100, 200. In one aspect, product picking module 540 is of the type shown in FIG. 3A-B. In another aspect, product picking module 540 may have alternative forms.

In another exemplary embodiment, optional stop barrier 543 is movable along the longitudinal axis of product picking module 540, under the actuation of an actuator (e.g. a stepper motor), connected to stop barrier 543.

Product picking module 540 is aligned with the sub-shelf of shelf 520, where the desired (i.e. user-selected) product is held, so that the upper surface of conveyor module 544 is positioned leveled with or under the lowest part of shelf 520 so that second rotating picking member 548 is aligned (still at its disengaged position), and protrudes underneath product 523, with the gap running along the sub-shelf holding the product.

FIG. 5B shows the picking of the selected product by the product picking module according to FIG. 5A. The actuator connected with picking member 548 is actuated to rotate picking member 548 to its engaged position, which is above the top level of conveyor module 544, and through the gap running along the sub-shelf holding the product. By rotating picking member 548 to its engaged position, picking member 548 pushes the bottom side of the first product 523 and lifts it upwards or over product stop member 521, so that first product 523 is now freed from stop member 521 and at the same time the position of first product 523 on the sub-shelf is left vacant and picking member 548 is actuated back to its disengaged position, thereby products 524, 525, 526 remaining on the sub-shelf slide all the way until product stop member 521. First product 523 topples towards product picking module 540 under the force exerted to it by sliding products 524, 525, 526 that remain on the sub-shelf.

FIG. 5C shows the loading of the selected product onto the product picking module according to FIG. 5B. Toppling first product 523 lands on conveyor module 544.

FIG. 5D shows the picking of the second product onto the product picking module according to FIG. 5C. Conveyor module 544 is rotated in one direction, moving first product 523 to contact with stop barrier 543. The actuator connected with picking member 548 is actuated to rotate picking member 548 to its engaged position, which is above the top level of conveyor module 544, and through the gap running along the sub-shelf holding second product 524. By rotating picking member 548 to its engaged position, picking member 548 pushes the bottom side of second product 524 and lifts it over product stop member 521, so that second product 524 is now freed from stop member 521 and at the same time the position of second product 524 on the sub-shelf is left vacant and picking member 548 is actuated back to its disengaged position, thereby products 525, 526 remaining on the sub-shelf slide all the way until product 525 comes into contact with product stop member 521. Second product 524 topples towards product picking module 540 under the force exerted to it by sliding products 525, 526 that remain on the sub-shelf.

FIG. 5E shows the loading of the second product onto the product picking module according to FIG. 5D. Toppling second product 524 lands on conveyor module 544.

FIG. 5F shows the movement of the second product along the product picking module according to FIG. 5E. Conveyor module 544 is rotated in one direction, moving second product 524 to contact first product 523, which is also in contact with stop barrier 543.

In another exemplary embodiment, product 524 may have dropped partially over product 523 and partially touching conveyor module 544, thereby, when conveyor module 544 is rotated in one direction it moves second product 524 to partially slide over first product 523, which is in contact with stop barrier 543.

FIG. 5G shows the picking of the third product onto the product picking module according to FIG. 5F. The actuator connected with picking member 548 is actuated to rotate picking member 548 to its engaged position, which is above the top level of conveyor module 544, and through the gap running along the sub-shelf holding third product 525. By rotating picking member 548 to its engaged position, picking member 548 pushes the bottom side of the third product 525 and lifts it over product stop member 521, so that third product 525 is now freed from stop member 521 and at the same time its position on the sub-shelf is left vacant and picking member 548 is actuated back to its disengaged position, thereby fourth product 526 remaining on the sub-shelf slides all the way until it contacts product stop member 521. Third product 525 topples towards product picking module 540 under the force exerted to it by the sliding products that remain on the sub-shelf.

FIG. 5H shows the loading of the third product onto the product picking module according to FIG. 5G. Toppling third product 525 lands on conveyor module 544.

In another exemplary embodiment, third product 525 may have dropped partially over second product 524 and partially touching conveyor module 544, thereby, if and when conveyor module 544 is rotated in one direction it moves third product 525 to partially slide over second product 524, which is in contact with first product 523, which in turn is in contact with stop barrier 543.

The dimensions of the product picking module and of the products are not depicted in scale. As such the skilled reader can appreciate that more products may be accommodated on the product picking module. The dimensions of the product picking mode may also vary among different exemplary implementations.

FIG. 5I shows the alignment and the transfer of the third product from the product picking module, according to FIG. 5H, to the dispenser area. Third product 525 is optionally scanned on product picking module 540 for verification of the loaded product. In one aspect first 523, and second 524 products are optionally scanned and verified together with third product 525, or in another aspect they are scanned and verified previously, when they were loaded onto product picking module 540. For instance, a scanner (e.g. Infra-Red (IR), or a camera) may scan the loaded product(s)'s barcode, Quick Response (QR) code, label, etc. and use the scanned image to either automatically identify and verify the products and their details (e.g. size, expiry date, etc.) or send the scanned image to human operator for manual verification (e.g. for the sale of medicaments or other regulated products). One or more scanners may be used to scan one or more sides of the product(s) for acquiring all the necessary information which may be positioned on more than one sides of the product(s).

In an alternative exemplary implementation, where an intermediate storage module is used, products 523-525 are first loaded on the intermediate storage module 450 and then scanned.

In yet another exemplary implementation, products 523-525 are scanned both on product picking module 540 and on intermediate storage module 450.

If the scanned third product 525 is verified and approved, third product 525 is moved from product picking module 540 (or from intermediate storage module 450) over to dispenser module 560 by actuating conveyor module 544 in one direction (or intermediate conveyor module 455 if the product was previously loaded on intermediate storage module 450). The product is then ready for collection by the client.

FIG. 5J shows the transfer of the third product from the product picking module, according to FIG. 5H, to the product dispose module. If the scanned third product 525 is not verified or approved, third product 525 is moved from product picking module 540 (or the intermediate storage module 450) over to product dispose module 570 by actuating conveyor module 544 in one direction (or intermediate conveyor module 455 if the product was previously loaded on intermediate storage module 450). The product can then be collected by service staff for recycling, disposal, or restocking.

FIG. 5K shows the loading of the second product from the product picking module to its sub-shelf, according to FIG. 5J. Product picking module 540 is aligned with the sub-shelf of shelf 520 (as described in FIG. 5A) but at the top end of stop member 521 (or higher), and conveyor module 544 is rotated in another direction to move second product 524 towards fourth product 526, which fourth product 526 rests in contact with stop member 521. As conveyor module 544 continues to move second product 524, second product 524 slides over stop member 521 and pushes fourth product 526 along its sub-shelf and away from stop member 521, effectively leaving an empty space between fourth product 526 and stop member 521. When second product 524 has sled at least half its length over stop member 521, second product 524 topples over stop member 521 onto the sub-shelf.

FIG. 5L shows the completion of the loading of the second product from the product picking module to its sub-shelf, according to FIG. 5K. Once second product 524 starts toppling over stop member 521 onto the sub-shelf, only the force exerted by fourth product 526 as it slides downwards the sub-shelf acts on second product 524, which results in both second product 524 and fourth product 526 sliding along the sub-shelf until second product 524 comes into contact with stop member 521. This way second product 524 is restocking the sub-shelf, while fourth product 526 comes at rest in contact with second product 524.

FIG. 5M shows the loading of the first product from the product picking module to its sub-shelf, according to FIG. 5M. Product picking module 540 is already aligned with the top end of stop member 521 (or higher) of the sub-shelf of shelf 520, and conveyor module 544 is rotated in another direction to move first product 523 towards second product 524, which second product 524 rests in contact with stop member 521. As conveyor module 544 continues to move first product 523 towards the sub-shelf, first product 523 slides over stop member 521 and pushes second product 524 (and fourth product 526 which is in contact with second product 524 on the distant to stop member 521 side of second product 524) along its sub-shelf and away from stop member 521, effectively leaving an empty space between second product 524 and stop member 521. When first product 523 has sled at least half its length over stop member 521, first product 523 topples over stop member 521 onto the sub-shelf.

FIG. 5N shows the completion of the loading of the first product from the product picking module to its sub-shelf, according to FIG. 5M. Once first product 523 starts toppling over stop member 521 onto the sub-shelf, only the force exerted by second product 524 as it slides downwards the sub-shelf acts on first product 523, which results in both first product 523, second product 524, and fourth product 526 sliding along the sub-shelf until first product 523 comes into contact with stop member 521. This way first product 523 is restocking the sub-shelf, while second product 524 and fourth product 526 come at rest in contact with first product 523.

During loading the products back to their positions in the sub-shelf, product picking module 540 may optionally move (above and) towards the sub-shelf for pushing each loaded product to the sub-shelf and ensuring that each loaded product does not risk falling again over stop member 521.

The result of the application of the methodology described in FIG. 5A-N is to allow a customer to select of a product at any position inside a stack of products, where the stack contains any number of different types of products (of the same or different dimensions) standing on any of their faces, and then replacing the products back to their original positions in the stack, except for the selected product which is dispensed or discarded. The result of the use of this methodology is to increase the capacity of different product types in automatic vending machines and to better adapt the quantities of the stocked products to the expected sales volumes of each product type between subsequent restocking of the vending machine. As a result, restocking costs and lost sales are reduced.

Methodology

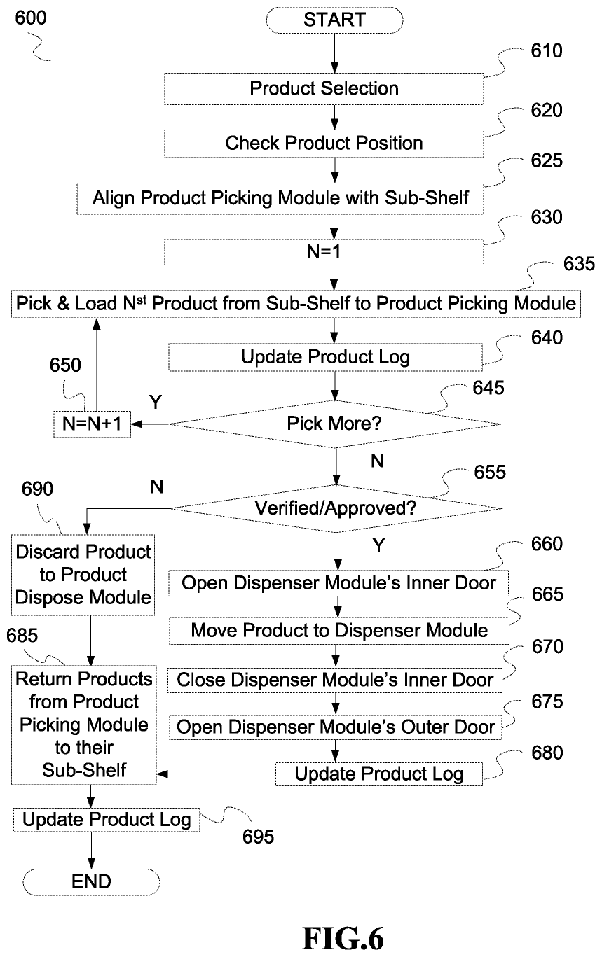

FIG. 6 shows a high-level flow diagram of an exemplary methodology for the operation of the automatic vending machine of the present invention. Methodology 600 starts with a client selecting a product 610 stocked in the automatic vending machine, by pressing a button, or via a Graphical User Interface (GUI) presented on a screen on the outside of the vending machine. Alternatively, the client may use his mobile device or other computing device to connect to the vending machine (e.g. by scanning a QR code or by loading a webpage of the company operating the vending machine and selecting the specific vending machine from a list of available vending machines), and then select a product in stock at the vending machine.

The product choice is received by the controller of the vending machine 610, which then checks 620 the inventory of the vending machine, e.g. by querying a database, or by looking up the product in a product log file, or by any similar method known in related art. Upon confirmation of the availability of the product, the product code is used to retrieve its position (i.e. shelf, sub-shelf, position in the sub-shelf stack) since the product position is associated with the said produce code. In another aspect the product code is used to retrieve the orientation of the product, i.e. on which of its faces it stands in the stack, which is used to calculate the exact location of the products on the sub-shelf. Orientation can be determined by processing sensory data with data relating to the dimensions associated with a product code. In one aspect the database, or product log file, etc. is locally stored at the vending machine (e.g. at a volatile, or a non-volatile storage module, or a combination thereof). In another aspect, it is remotely stored at a server, or at the cloud. In yet another aspect, it is stored in a combination of local and remote storage modules.

Having retrieved the product position, the controller calculates and sends control signals to the actuators (e.g. stepper motors) controlling the position of product picking module 540. These control signals correspond to a specific and accurately calculated actuation of the respective actuators, and to specific rotation, or displacement of the respective movable members and modules of picking module 540. Similar types of control signals are used for all actuators of the vending machine. The correspondence between control signals, actuation, and rotation and displacement, may, in one aspect, be calculated using a mathematical formula (e.g. for a stepper motor, 10 steps corresponds to 1 degree of rotation of a step motor, or 1 cm of displacement of the moving member/module), while in another aspect the correspondence may be pre-calculated and stored in a configuration or similar file, which is simply looked up by a controller module (see later for a description of the controller module) during the operation of the vending machine.

Upon receipt of the control signals, the actuators move product picking module 540 to align 625 with the lower end (i.e. the one proximal to stop member 521) of the sub-shelf containing the collected product (as described in FIG. 5A-N). In other words, product picking module is moved so that the product picking member is positioned, in its disengaged position, under the first product and aligned with the gap running along the sub-shelf. In an alternative exemplary implementation, position sensors (e.g. IR, proximity, magnetic, capacitive, pressure, mechanical) may also be available at each shelf/sub-shelf, which sensors detect the position of product picking module 540 and send the generated signals to the controller to help it confirm the actual positioning of product picking module 540. These sensors are optional as the use of accurate or intelligent actuators (e.g. stepper motors) can allow the controller to accurately control the exact position of product picking module 540 without the additional cost associated with position sensors at each self. In a modification of the exemplary implementation, 2-3 position sensors may be optionally used, one for each of the x, y, and (optional) z axis of motion of product picking module 540, so as to provide offset signals for calibration purposes, so as to offset incidental miss-alignments that could be produced during the movement of product picking module 540 by the actuators. Alternatively, a single position sensor may be used to provide offset signals for calibration purposes.

A counter N is set to N=1 630 for accessing first product 523, which is in contact with stop member 521 on the selected sub-shelf. The counter may be implemented either in software or in hardware. Product picking module 540 is then commanded by the controller to pick and load 635 first product 523 onto conveyor module 544 (as described in FIG. 5A-C) by actuating the actuator connected with second rotating picking member 548, and then actuates the actuator connected with conveyor module 544 to move first product 523 away from the sub-shelf, and if optional stop barrier 543 is installed, until first product 523 comes into contact with stop barrier 543 (as described in FIG. 5D). The controller then updates the product log 640 and in particular the new positions of first product 523 (i.e. first position on conveyor module 544) and second 254, third 525, and forth products 526 (i.e. first, second and third positions, respectively, on the sub-shelf).

If another product needs to be picked 645 and loaded onto product picking module 540, counter N is set to N=N+1 (i.e. increased by 1) 650 and methodology 600 branches back to step 635, for as many times an additional products needs to be picked from the sub-shelf; in the present example, the first three products on the sub-shelf are to be picked, because the third product corresponds to the client's selection. Every time an additional product is picked and loaded onto product picking module 540, the controller commands conveyor module 544 to move the newly loaded product (and the previously loaded products) away from the sub-shelf, and if optional stop barrier 543 is installed, until all loaded products come into contact with stop barrier 543 (as described in FIG. 5D-H). The described operation maintains the relative order of the products.

First 523, second 524 and third 525 products in the present example are of different categories and/or sizes, and are placed in the same sub-shelf for increasing the capacity of different product categories of the vending machine and/or for better matching the quantities of the stocked products for each product category with the forecasted sales volumes per product category.

If no more products are to be picked and loaded 645 onto product picking module 540, the controller checks if the last loaded product, i.e. third product 535 in the present example, is verified or approved 655 (as previously described using scanners and/or cameras to ensure the correct product is loaded and that the product has not expired, etc.). In one aspect, the verification or approval step 655 is optional.

If third product 535 is not verified and/or approved 655, the controller first detects if product picking module 540 is aligned over product dispose module 470, and if no, the controller commands the actuators controlling to motion of product picking module 540 to actuate for moving product picking module 540 to align over product dispose module 470, and optionally at a predetermined height from product dispose module 470 so as ensure that dropping third product 535 into product dispose module 470 will not damage third product 535 or any product already in product dispose module 470.

If product picking module 540 is aligned over product dispose module 470, the controller discards 690 third product 535 by commanding the actuator connected to conveyor module 544 to rotate conveyor module 544 until third product 535 drops into product dispose module 470. Any optionally installed position sensors may be used for the controlling of this operation. The controller is so programmed as to ensure that only third product 535 is dropped and that first 523 and second 524 products remain onto conveyor module 544. The controller then updates the product log. The controller then commands the actuators of product picking module 540, to first (if needed) align product picking module 540 with the sub-shelf where the products were originally stored, and then to return 685 second product 524, and then first product 523 to their storage positions in the sub-shelf 520, and finally to update the product log 695.

If third product 535 is verified and approved 655, third product 535 is not discarded, and if an inner door is installed at dispenser module 560, the controller commands an actuator connected to the inner door to open the inner door 660. The controller than commands the actuator connected to conveyor module 544 to rotate conveyor module 544 until third product 535 is moved 665 to dispenser module 560, close 670 inner door of dispenser module 560, and open 675 outer door of dispenser module 560 for the client to collect his product. The inner and outer doors of dispenser module 560 are operated by the actuators respectively connected to the inner and outer doors.

Effectively inner door 270 and outer door 280 form an optional access control mechanism, controlling external access to dispenser module 560 and the interior of vending machine 100, 200.

In an alternative exemplary implementation (not shown in FIG. 6), where an intermediate storage module 450 is installed in the automatic vending machine, the controller commands the actuator connected to conveyor module 544 to rotate conveyor module 544 until third product 535 is moved to intermediate storage module 450. This operation may be facilitated by the controller commanding the actuator connected with intermediate conveyor module 455 to actuate intermediate conveyor module 455 to rotate for loading third product 535 onto intermediate storage module 450. Third product, is verified or approved 655 on intermediate storage module 450 (as previously described using scanners and/or cameras to ensure the correct product is loaded and that the product has not expired, etc.) and not on product picking module 540.

In a modification of this exemplary implementation, where an intermediate storage module 450 is installed in the automatic vending machine, the controller may verify and approve 655 third product 535 twice, a first time while third product 535 is on product picking module 540, and a second time while third product 535 is on intermediate storage module 450. Such a double verification and approval 655 may be used in the sale of regulated (e.g. medicaments) or expensive products, or for any product on sale. If an inner door is installed at dispenser module 560, the controller commands the actuator connected to the inner door to open the inner door 660. At a second time, the controller commands the actuator connected to intermediate conveyor module 455 to rotate for moving 665 third product 535 to dispenser module 560, and then closes 670 inner door of dispenser module 560, and opens 675 outer door of dispenser module 560 for the client to collect his product. The inner and outer doors of dispenser module 560 are operated by the actuators respectively connected to the inner and outer doors.

The controller then updates the product log 680 and commands the actuators of product picking module 540, to first (if needed) align product picking module 540 with the sub-shelf where the products were originally stored, and then to return 685 second product 524, and then first product 523 to their storage positions in the sub-shelf 520, and finally to update the product log 695.

So, the returned to the sub-shelf products are now in the following order, starting from product stop member 521: first product 523, second product 524, fourth product 526, etc. Effectively, only the product selected by the client has been removed from the product stack at the sub-shelf, and the remaining products are maintained in the original relative order, therefore allowing the controller to efficiently locate them, using the information stored in the product log, and serve future client purchases. The product log is also used and updated by the controller at every refill of the vending machine.

It is apparent to persons of ordinary skill in related art that the methodology 600 is presented adapted to the specific example where the client selects a product (i.e. third product 535) stored at a sub-shelf of a shelf 520. Adaptation of methodology 600 to other storage examples in alternative shelves (520/220, or 230), sub-shelves, product position in sub-shelved, products of different dimensions stocked in the same sub-shelf, etc. is obvious to the skilled person and fall with the scope of protection of the present invention. E.g. using the information in the product log (i.e. product code, product type, shelf, sub-shelf, product position in sub-shelf, and product dimensions) the controller can calculate the exact positions the various moving elements of the automatic vending machine need to be rotated or moved, and can create appropriate control signals to send to the actuators connected to the moving elements at the correct timing, while coordinating with other modules (like the payment module, or the product selection mechanism, e.g. button or other UI) to create and service a client order for the sale of a product. In specialized vending machines, e.g. for selling medicaments, the controller may also communicate with additional modules, like a teleconferencing module for contacting a trained pharmacist, a scanner for scanning a prescription, a labeling module for printing and attaching a label to the medicament boxes prior to dispensing them, etc.

It is apparent to persons of ordinary skill in related art that methodology 600 can be used as is, or adapted in an obvious way, for use with automatic vending machines forming part of the prior art. This means that methodology 600 may be applied to different electromechanical, electronic and software components than these described in the present innovative solution. Such possible application of methodology 600 to prior art vending machines (that differ from the vending machine of the present innovative solution) does not take away novelty of the present innovative solution, irrespective of whether the present innovative solution relates to methodology 600, or to the electromechanical, electronic, and software components presented below.

Electronics Architecture

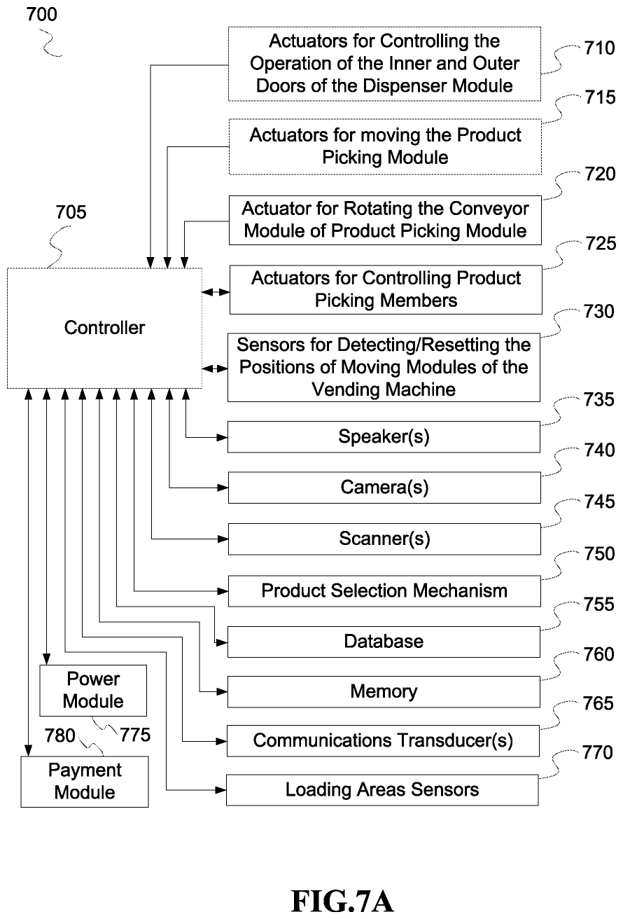

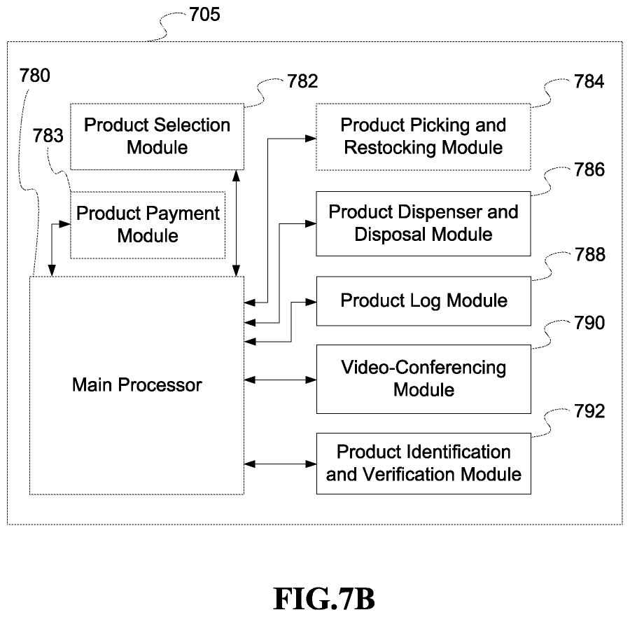

FIG. 7A shows an exemplary high-level system electronics architecture diagram of the automatic vending machine of the present invention. Vending machine 100, 200 houses a number of hardware (electromechanical and electronic) components 700 controlled by a controller 705, which is connected to actuators 710 for controlling the operation of the inner and outer doors of dispenser module 560, actuators 715 for moving the product picking module 540, actuator 720 for rotating conveyor module 544 of product picking module 540, actuators 725 for controlling product picking members 347, 348 of product picking module 540, optional sensors 730 for detecting/resetting the positions of moving modules of the vending machine, optional speaker(s) 735 for providing instructions to clients when they are in front of the vending machine, optional camera(s) 740 for scanning products and/or for video-conferencing, optional scanner(s) 745 for scanning the selected products and/or medicament prescriptions, product selection mechanism 750, database 755 or other storage (e.g. any known type of memory module) for storing the product log, volatile and/or non-volatile memory 760 for storing software and/or data, communications transducer(s) 765 (e.g. wireless or wired using any known technology, including Ethernet, cellular communication adapters, etc. for communication between the modules of the vending machine and external servers and systems), loading areas sensors 770 (for detecting products on product picking module 540, on intermediate storage module 450, in dispenser module 560, or in product dispose module 470, or for detecting open and closed inner and outer doors of dispenser module 560), power module 775 for powering up all modules of the vending machine, and payment module 780 (which according to the specific exemplary implementation may contain any or all of coin, banknote, credit/debit card, wireless payment, etc. submodules). It is apparent to persons of ordinary skills in related art that the hardware modules of architecture 700 are presented by means of example and additions, deletions, or merging of hardware modules fall within the scope of protection of the present innovative solution.

FIG. 7B shows an exemplary high-level electronics architecture of the controller of the automatic vending machine of the present invention. Controller 705 has a main processor 780 for controlling all other modules and for implementing methodology 600, processes and data calculations, and connected with a product selection module 782 (which controls the buttons or other user interface used by the client to select a product), a product payment module 783 (which controls hardware payment module 780), a product picking and restocking module 784 (which controls the operation of product picking module 540 for picking and loading products from the sub-shelves—it includes all moving parts of the product picking module 540, and exploits sensor, scanner and camera data), a product dispenser and (optional) disposal module 786 (which controls the operation of product picking module 540 for dispensing the selected product from product picking module 540 to dispenser module 560 and for disposing the selected product to product dispose module 470, according to the outcome of the identification and verification of the product loaded on product picking module 540—it controls all moving parts of product picking module 540, and exploits sensor, scanner and camera data), a product log module 788 (which logs product related data, such as product type, dimensions, expiry date, position in sub-shelf, and actions on the product, such as picking, loading, dispensing, discarding, reason for discarding, etc.), an optional video-conferencing module 790 (which controls video conferencing with an operator, and involves the control of cameras, scanners, speakers, and sensors), a product identification and verification module 792 (which identifies and verifies the products that have been loaded onto product picking module 540—it uses data from scanners, cameras and sensors and its result for the product identification and verification operation is used by main processor 780 to control the operation of product dispenser and disposal module 786),

It is obvious to a person skilled in related art that the exemplary controller 705 may be modified by adding, deleting and merging modules 782-792 without departing from the scope of protection of the present innovative solution. The skilled person may, for example, consider that the modification of controller 705 may be due to the implementation of certain modules in software, firmware, hardware, or a combination thereof, or its adaptation for use in any type of automatic vending machine known in the art, or for implementing modifications to methodology 600.

Software Architecture

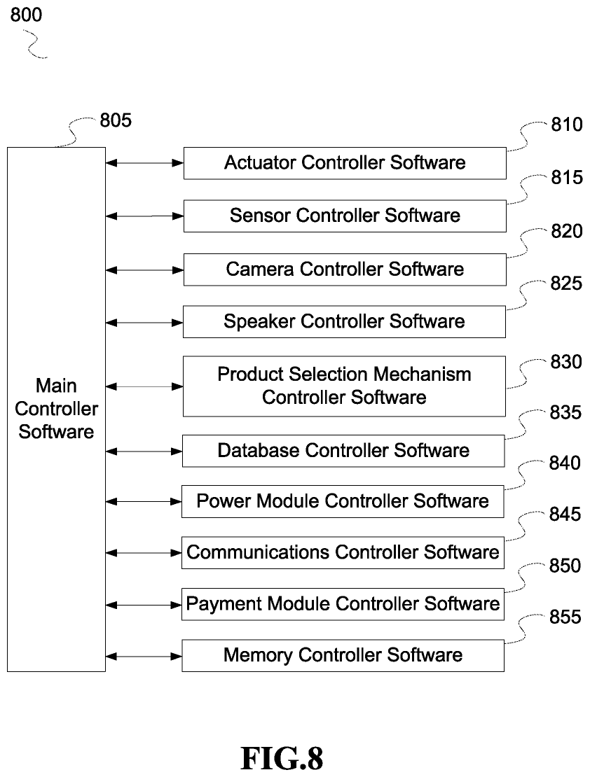

FIG. 8 shows an exemplary high-level software architecture diagram of the automatic vending machine of the present invention. Controller 705 runs main controller Software (S/W) 805 which controls the operation of automatic vending machine 100, 200 and implements methodology 600 by communicating with the following software modules: actuator controller S/W 810, sensor controller S/W 815, camera controller S/W 820, speaker controller S/W 825, product selection mechanism controller S/W 830, database controller S/W 835, power module controller S/W 840, communications controller S/W 845, payment module controller S/W 850, and memory controller S/W 855.

It is apparent to persons of ordinary skill in related art that the software modules of architecture 800 are presented by means of example and additions, deletions, or merging of hardware modules fall within the scope of protection of the present innovative solution. For example, the skilled person may consider as obvious that modifications of S/W modules 800 may match the actual implementation of hardware components 700, or controller 705.

Also, it is apparent to persons of ordinary skills in related art that the software modules of architecture 800 may be implemented in firmware, machine code, medium or high-level programming languages, abstract programming languages (e.g. eXtensible Markup Language (XML)-based programming languages), or a combination thereof, or that some of these software modules may be implemented in dedicated hardware (e.g. using purpose-built microchips or micro-controllers, or Application Specific Integrated Circuits (ASIC)), or other hardware technology, or may run entirely at the vending machine, or at distributed servers, or at the cloud with which the vending machine is in wireless or wired communication, or a combination thereof.

Main controller software 805 is designed to use product type (i.e. product code), dimensions, position in sub-shelf, sensor data, product log data, user selection, payment data, etc. to calculate the actions to be taken for controlling the moving parts of the vending machine. For example, main controller software 805 uses these data to calculate control codes (e.g. a number of pulse, or a voltage level, or a digital code number) which it sends to the actuators of the vending machine for aligning product picking module 540 with a sub-shelf, dispenser module 560, product dispose module 470, for actuating picking member 547, 548, for opening and closing inner and outer doors of dispenser module 560, etc.

The present innovative solution can also be implemented by software written in any programming language, or in an abstract language (e.g. a metadata-based description which is then interpreted by a software or hardware component). The software may run on the previously presented hardware.

In another exemplary implementation, the software may run on a general-purpose hardware or computing device, apparatus or system and effectively transforms the general-purpose hardware or computing device, apparatus or system into one that specifically implements the present innovative solution.

In another exemplary implementation, the software may run on a special-purpose hardware or computing device, apparatus or system and effectively transforms the special-purpose hardware or computing device, apparatus or system into one that specifically implements the present innovative solution.

The exemplary implementations of FIG. 1-2, FIG. 4A-H and FIG. 5A-N show shelves and sub-selves arranged at an inclination with respect to the horizontal plane, so that the shelves and sub-selves allow products placed on them (e.g. in a unitary-width stack of products) to slide under the influence of gravity towards the product stop member, until the first product in the stack comes into contact with the product stop member. So, the inclined shelves and sub-shelves are effectively a product stack movement mechanism. In alternative exemplary implementations, the shelves and sub-selves are arranged parallel in all directions with the horizontal plane such that the unitary-width stack of products does not slide under the influence of gravity. In such implementations, the shelves and sub-selves are equipped with a product movement or push mechanism that moves or pushes the products towards to product stop member. Such a mechanism, is known in the art and may take the form of, e.g. a push member movable along the length of the sub-shelf, an elastic member in contact with the last product in the unitary-width stack of products, etc. Such a mechanism is effectively a product stack movement mechanism.

Exemplary Implementation Using a Modified Product Picking Module

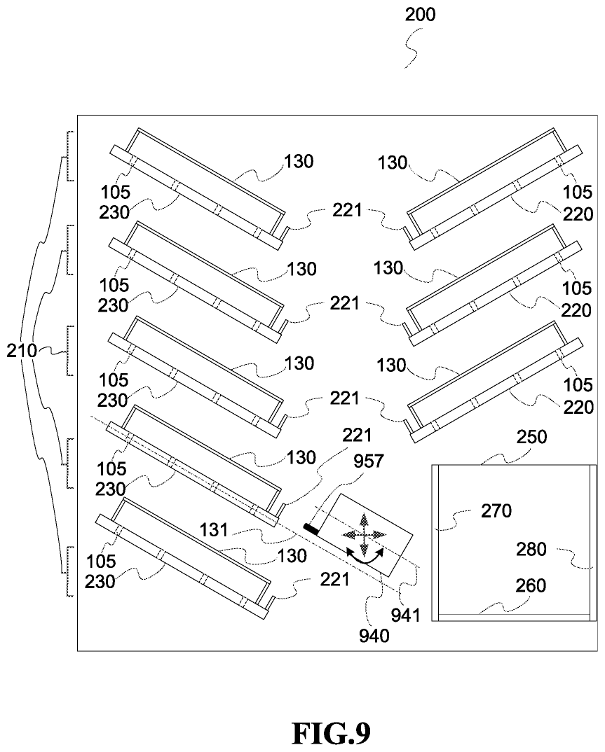

FIG. 9 shows a simplified, behind the cover, side view of an automatic vending machine. Vending machine 200 has a modular storage system 210 in the form of a rack with a movable set of shelves 220, arranged above each other, each aligned with the width of the frontal face of vending machine 200, and attached on a rack system (not shown). Shelves 220 are position at an angle to the horizontal plane so that each forms a ramp inclined towards the inside of the vending machine, and partitions 130 are movably attached on shelves 220 to partition them into sub-shelves.

At the lower end of each of sub-shelf of shelves 220 is attached a product stop member 221, which is intended to form a barrier preventing products from slipping off the respective sub-shelf. In one aspect, product stop member 221 has a height, protruding over the top surface of the sub-shelf, that is chosen so as to provide enough support to the product it is in contact with, while at the same time allowing the product to overcome product stop member 221 and become free to fall off the sub-shelf once the product is almost totally or totally raised over the top of product stop member 221. Typically, the height of product stop member 221 is chosen between 10%-50% of the height of the product is in contact with, but other relative heights of product stop member 221 can be selected. The height of the loaded product is the height of the product as loaded, i.e. depends on the face on which the product lies upon. In another aspect, an individual product stop member 221 is attached at the lower end of each sub-shelf, while in another aspect, a single product stop member 221 is used per shelf 220, thereby the same product stop member 221 is used across all sub-shelves of the same shelf.

Product picking module 940 is oriented at an angle to the horizontal plane as indicated by the longitudinal axis 941 (and may be at about the same angle as the sub-shelves of shelf 220 as indicated by the longitudinal axis 131), is aligned with a sub-shelf of a shelf 220 and is used to pick the product in contact with product stop member 221 at the sub-shelf using product picking member 957, and then drops the picked product to the dispenser area 250, or into the optional dispenser conveyor 260. Product picking module's 940 inclination allows the picked product to topple and slide under the influence of gravity from the product stack in the sub-shelf onto product picking module 940.

Dispenser area 250 has two optional shutters an internal shutter 270 and an external shutter 280. External shutter 280 is always closed so as to prevent access from the outside to the inside of vending machine 200 and only opens for allowing clients to collect their selected product or products. Before opening external shutter 280, internal shutter 270 is closed so as to isolate dispenser area 250 from the inside of vending machine 200. Internal shutter 270 is opened only if external shutter 280 is closed, for allowing the movement of the picked product from product picking module 940 to dispenser area 250. In a variation of the present exemplary embodiment, internal shutter is located at the upper side of dispenser area 250.

In an alternative exemplary embodiment, shelves 220 are replaced by shelves 230, which are aligned with the width of the posterior face of vending machine 200. In one aspect shelves 220 and 230 are identical, while in another aspect they differ. Shelves 230 operate identically or similarly to the operation of shelves 220 and allow the operation of product picking module 940 and dispenser area 250 as previously presented for shelves 220.

In yet another exemplary embodiment, both shelves 220, 230 are installed inside vending machine 200 for increasing the capacity of vending machine 200. In this exemplary embodiment, product picking module 940 and dispenser area 250 are designed to operate with both shelves 220, 230. For this reason product picking module 940 can rotate about the vertical axis.

Shelves 220, 230 have gaps running along their width (i.e. perpendicular to the longitudinal axis running along the width of the face or back of vending machine 200).

In the above variations of the sixth exemplary embodiment, product picking module 940 can rotate about the vertical axis for aligning with and positioning its product picking member 957 proximal to product stop member 221 of the selected subself or to dispenser area 250.

Modified Product Picking Module

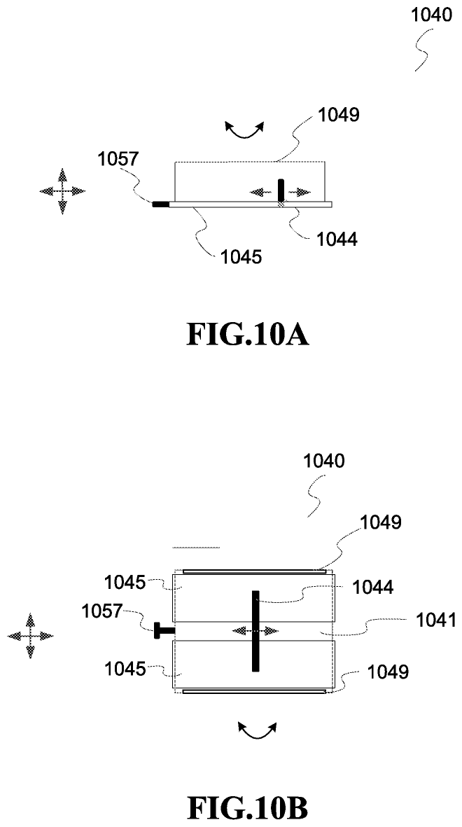

FIG. 10A shows a simplified side view, along the longitudinal axis, of an exemplary modified product picking module. Product picking module 1040 has a main body (or product loading platform) 1045 housing actuators (e.g. stepper motors). At the upper face of product picking module's 1040 loading platform 1045 are attached two perpendicular barrier members (or bordering sides) 1049 onto two opposing edges of loading platform 1045. The other opposing edges of loading platform 1045, are open and one of these open edges has a product picking member 1057, securely attached to and leveled with the top surface of loading platform 1045 and extending outwards of loading platform 1045, intended to pick a product from the stack of products in a sub-shelf that is in contact with product stop element 221 at the lower end of the inclined sub-shelf.

FIG. 10B shows a simplified top-down view of the exemplary product picking module of FIG. 10A. The loading platform has a gap or slot 1041 along its length through which a product unloading member 1044 protrudes above the top surface of loading platform 1045 and can move along the axis joining the two open edges of loading platform 1045. Product picking module 1040 is inclined longitudinally at about the longitudinal inclination of the sub-shelf with respect to the horizontal (or vertical) plane, so as to allow product picking member 1057 and product loading platform 1045 to form a ramp with the sub-shelf when aligned.

Product picking module 1040 is designed to movably attach on a frame installed inside vending machine 100, 200 for moving in the x, y, and optionally the z direction by using a positioning module (e.g. in its main body, or at the frame), that has 2 or 3 actuators, respectively. The frame onto which product picking module 340 moves in not shown in FIG. 9. Product picking module 340 is also designed to rotate about the vertical axis.

Product unloading member 1044 extends through slot 1041 and protrudes above the top surface of loading platform 1045, while it can be moved along slot 1041. Unloading member 1044 has a double function. First to act as a barrier preventing products loaded on loading platform 1045 from falling off of loading platform 1045, and second, to push loaded products off-loading platform 1045 and either towards dispenser area 250 for the customer to pick them up, discard area for discarding (e.g. for expired products), or to a sub-shelf for restocking or for replacing products in the product stack from where they were removed together with the product selected by the customer.

Loading the Product Picking Module

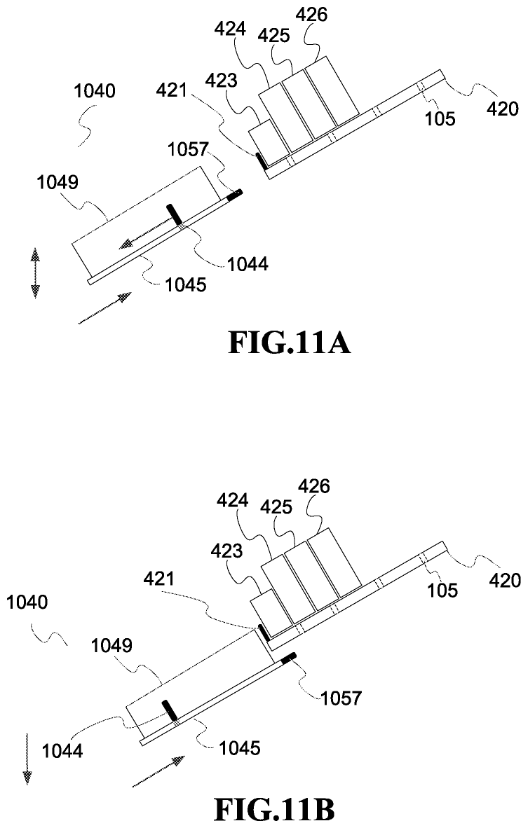

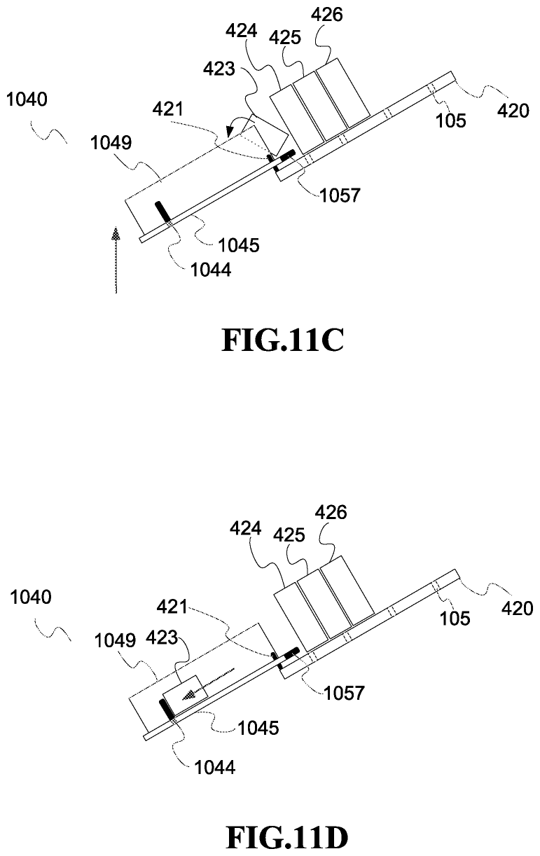

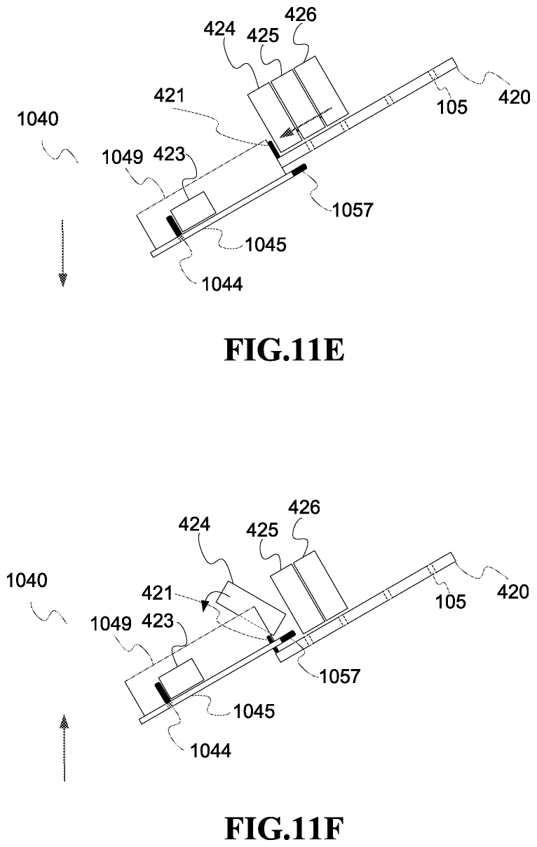

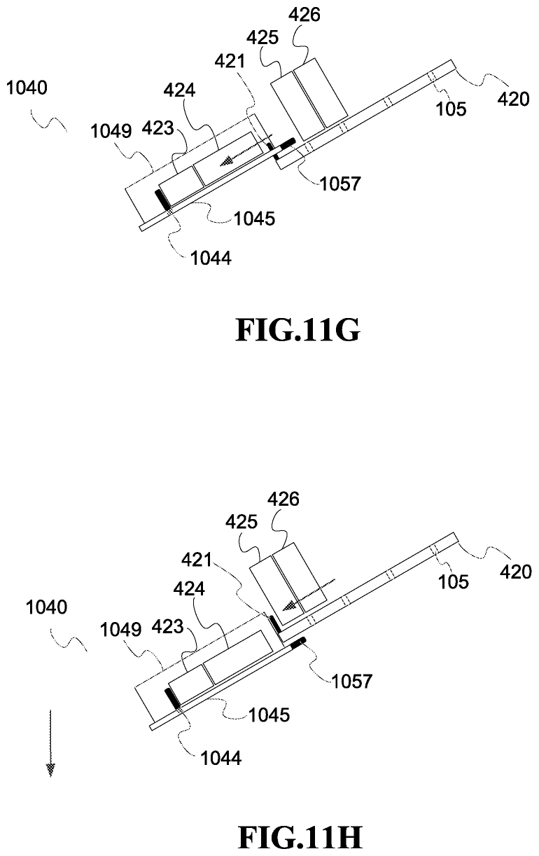

FIG. 11A shows a simplified side view, along the longitudinal axis, of the product picking module of the sixth exemplary embodiment, aligned with the sub-shelf for picking a selected product.

Shelf 420 is attached on the rack inside the vending machine and a sub-shelf is formed on shelf 420, and equipped with a product stop member 421. The product stop member 421 holds a unitary-width (or multiple-width) stack of products (stacked on any of their faces) in physical contact with each other (a first 423, a second, 424, a third 425, and a fourth 426 products—more products may be stacked but are not shown), where first product 423 is in physical contact with product stop member 421. Products 423-426 are of the same type and dimensions (or of different types and dimensions).

Product picking module 1040 has a main body (or loading platform) 1045, two barrier members (or border sides) 1049, an unloading member 1044, and a product picking member 1057.

Product picking module 1040 is aligned with the sub-shelf of shelf 420, where the desired product is held.

To remove the first product 423 of a stack (i.e. the product that is in contact with product stop member 421 at the lower end of the corresponding inclined sub-shelf) loading platform 1045 (i.e. the entire product picking module 1040) is moved towards the sub-sheld and until its longitudinal axis (i.e. the axis joining the two open edges of the loading platform) is aligned with the longitudinal axis of the sub-self (i.e. the axis passing from the product stop member and running along the shelf and the stacked products). This way the product picking member 1057 is aligned with the slot running longitudinally along the sub-shelf, and product picking member 1057 is dimensioned to movably fit inside slot 1041. Unloading member 1044 is moved along slot 1041 and distantly to product picking member 1057 for creating enough loading space for receiving products from the sub-shelf's stack of products. In one aspect, unloading member 1044 is moved prior to aligning loading platform 1045 with the sub-shelf, while in other aspects it is moved while or after aligning loading platform 1045 with the sub-shelf.

FIG. 11B shows a simplified side view, along the longitudinal axis, of the product picking module of the sixth exemplary embodiment, with its product picking member under the first product of the stack. Loading platform 1045 is lowered so that its product picking member 1057 is aligned with the sub-shelf's longitudinal slot (not shown) and is lower than the lower surface of the sub-shelf. Loading platform 1045 is moved towards the sub-shelf until its product picking member 1057 is positioned underneath first product 423 in the sub-shelf's stack and is aligned with the sub-shelf's slot.

FIG. 11C shows a simplified side view, along the longitudinal axis, of the product picking module of the sixth exemplary embodiment, with its product picking member toppling the first product from the stack. Then loading platform 1045 is raised until its product picking member 1057 has passed through the sub-shelf's longitudinal slot and pushes first product 423 upwards. Under the effect of the upward push received by product picking member 1057, first product 423 is lifted until it overcomes product stop member 421 of the inclined sub-shelf and topples onto inclined loading platform 1045 under the influence of gravity.

FIG. 11D shows a simplified side view, along the longitudinal axis, of the product picking module of the sixth exemplary embodiment, after it has loaded the first product. Once first product 423 has toppled it starts sliding downhill inclined loading platform 1045 until first product 423 touches unloading member 1044.

FIG. 11E shows a simplified side view, along the longitudinal axis, of the product picking module of the sixth exemplary embodiment, with its product picking member under the second product of the stack. At the same time, or immediately afterwards, loading platform 1045 is lowered until product picking member 1057 is located below the lower surface of the sub-shelf. Since the position previously occupied by first product 423 on the sub-shelf is empty, and since product picking member 1057 is now below the lower surface of the sub-shelf, second product 424 (and all other products 425, 426 in the product stack) slide(s) down the inclined sub-shelf until it/they touche(s) product stop member 421.

FIG. 11F shows a simplified side view, along the longitudinal axis, of the product picking module of the sixth exemplary embodiment, with its product picking member toppling the second product from the stack. Then loading platform 1045 is raised until its product picking member 1057 has passed through the sub-shelf's longitudinal slot and pushed second product 424 upwards. Under the effect of the upward push received by product picking member 1057, second product 424 is lifted until it overcomes product stop member 412 of the inclined sub-shelf and topples onto the inclined loading platform 1045 under the influence of gravity.

FIG. 11G shows a simplified side view, along the longitudinal axis, of the product picking module of the sixth exemplary embodiment, after it has loaded the second product. Once second product 424 has toppled it starts sliding downhill inclined loading platform 1045 until second product 424 touches first product 423, which in turn touches unloading member 1044.

FIG. 11H shows a simplified side view, along the longitudinal axis, of the product picking module of the sixth exemplary embodiment, after it has loaded the second product and lowered its product picking member below the sub-shelf. At the same time, or immediately afterwards, loading platform 1045 is lowered until the product picking member 1057 is located below the lower surface of the sub-shelf. Since the position previously occupied by second product 424 on the sub-shelf is empty, and since product picking member 1057 is now below the lower surface of the sub-shelf, third product 425 (and all other products 426 in the product stack) slide(s) down the inclined sub-shelf until it/they touch(es) product stop member 421.

The stack may contain any number of products and any product in the stack of products may be selected by the customer using the present venting machine. FIG. 11A-H show four products and assume the second product is the one selected by the customer; these are shown only by means of example and not for limiting the scope of protection of the present invention. The process may be repeated until the desired product in the stack (e.g. the n^{th} product) is loaded onto the loading platform, or until the desired number of products are loaded on the loading platform (in the case where the customer has ordered more than one items of the same type). Unloading member 1044 may be positioned at any position along the longitudinal axis of loading platform 1045. For maximum capacity when loading the loading platform, unloading member 1044 may be positioned at the positional farthest from product picking member 1057. The two bordering sides 1049 (together with the unloading member 1044) ensure that the product(s) loaded onto loading platform 1045 will not fall off loading platform 1045.

The dimensions of loading platform 1045 and of the other elements of product picking module 1040, as well as, the dimensional and orientation (i.e, the face on which they lie) of the products are not shown in scale. The skilled reader easily understands that more products can be accommodated on loading platform 1045 and products can stand on any of their faces on the sub-shelf.

Unloading the Product Picking Module for Restocking or Restacking

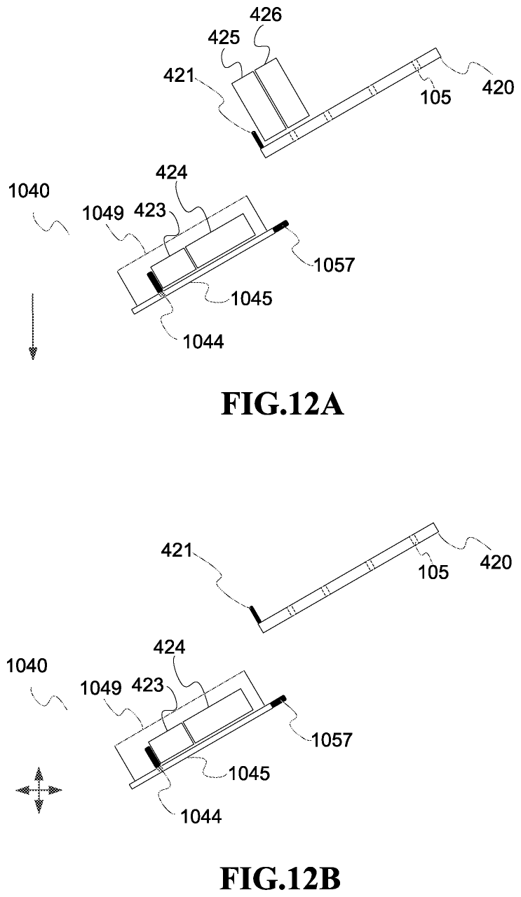

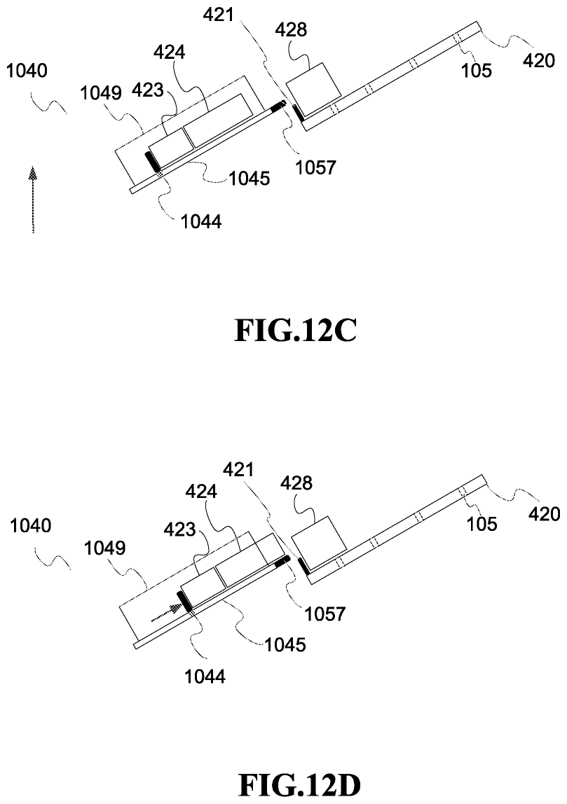

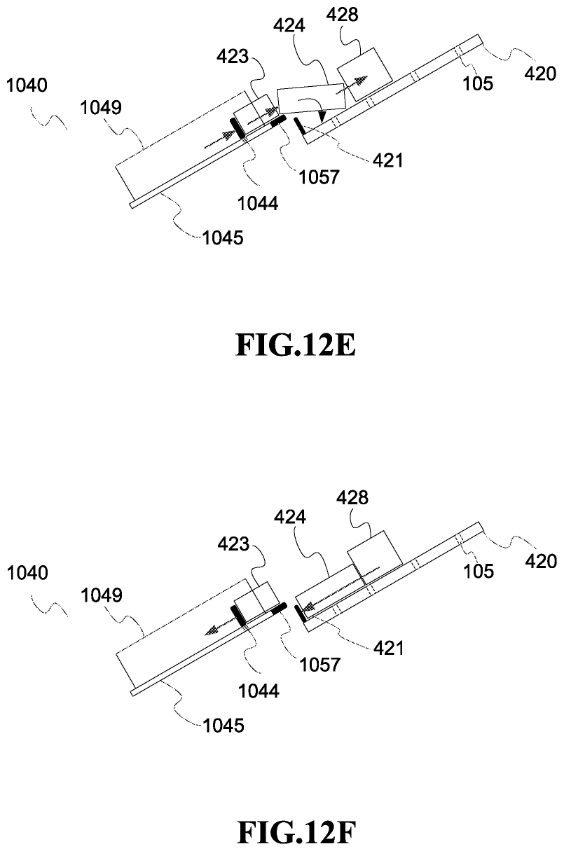

FIG. 12A shows a simplified side view, along the longitudinal axis, of the product picking module of the sixth exemplary embodiment, after it has loaded the second product and is moving away from the sub-shelf. Loading platform 1045 is lowered until the product picking member 1057 is distanced to the lower surface of the sub-shelf.

FIG. 12B shows a simplified side view, along the longitudinal axis, of the product picking module of the sixth exemplary embodiment, after it has loaded the second product and is being aligned with another sub-shelf of another shelf 420. Loading platform 1045 is moved for its product picking member 1057 to be aligned with another sub-shelf which contains fifth product 428 in contact with product stop element 421.

FIG. 12C shows a simplified side view, along the longitudinal axis, of the product picking module of the sixth exemplary embodiment, after it has aligned with the other sub-shelf and its product picking member is over product stop element 421 of the other sub-shelf. Loading platform 1045 is raised until the product picking member 1057 is over product stop element 421 of the other sub-shelf and in front of fifth product 428.

FIG. 12D shows a simplified side view, along the longitudinal axis, of the product picking module of the sixth exemplary embodiment, after its product picking member is positioned over the product stop element of the other sub-shelf, and the product unloading member pushes the loaded products from the product loading platform towards the other sub-shelf. Product unloading member 1044 pushes loaded products 423, 424 from product loading platform 1045 towards the other sub-shelf.

FIG. 12E shows a simplified side view, along the longitudinal axis, of the product picking module of the sixth exemplary embodiment, with its product unloading member pushing second loaded product 424 (via first loaded product 423) from the product loading platform onto the other sub-shelf, which second product 424, in turn, pushes fifth product 428, which slides uphill the sub-shelf. Product unloading member 1044 continues pushing loaded products 423, 424, (and 428) from product loading platform 1045 towards the other sub-shelf until second loaded product 424 overcomes product stop element 421 and drops on the other sub-shelf.

FIG. 12F shows a simplified side view, along the longitudinal axis, of the product picking module of the sixth exemplary embodiment, after the second product has been stacked onto the other sub-self. Product unloading member 1044 retracts to allow second product 424 (and fifth product 428) to slide under the influence of gravity until they touch product stop element 421. First product 423 continues touching product unloading member 1044 as it slides downhill product loading platform 1045 under the influence of gravity.

The operation continues with product picking module 1040 moving and aligning with the sub-shelf holding third 425 and fourth 426 products, i.e. the sub-shelf where first product 423 was originally stacked. This way first product 423 is restacked in its original stack and in the same position (i.e. first), while second product 424 has been removed from its original stack and moved over to a new stack (now as first product in the new stack) at the other sub-shelf. This operation allows rearranging the stock in the automatic vending machine. The exact operation may be used for restocking the vending machine, where the stack initially holding four products 423-426 is located at a sub-shelf of a restocking shelf or rack of shelves that is loaded to (and unloaded from) the automatic vending machine much like inserting or removing a cartridge. The other sub-shelf is at a rack of shelves of the automatic vending machine used for servicing customer requests for product purchase. Such operations can significantly reduce restocking and restacking times and minimize or eliminate manual operations that would otherwise have to be performed by human operators, thus slushing costs.

During the above operations, the automatic vending machine tracks and logs the position and movement of products, their dimensions, the face on which they stand upon, and their relative positions in the stacks, using sensors, so as to ensure that only the desired products will be restoked and restacked and that their order in the product stacks is known for correctly dispensing and disposing them.

Unloading the Product Picking Module for Dispensing or Disposal

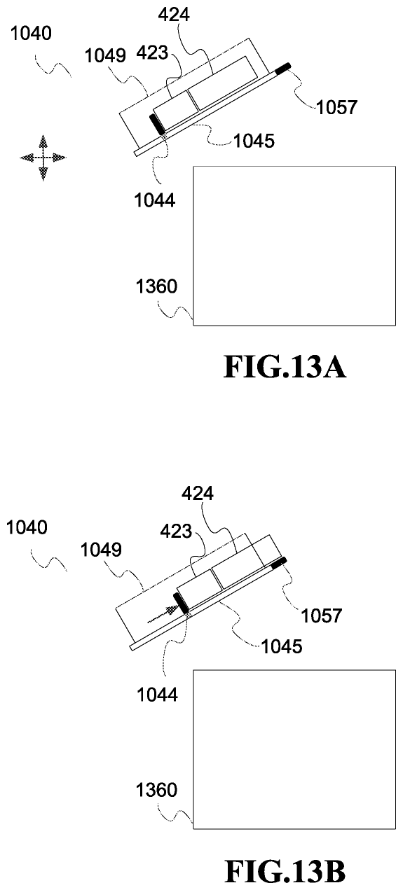

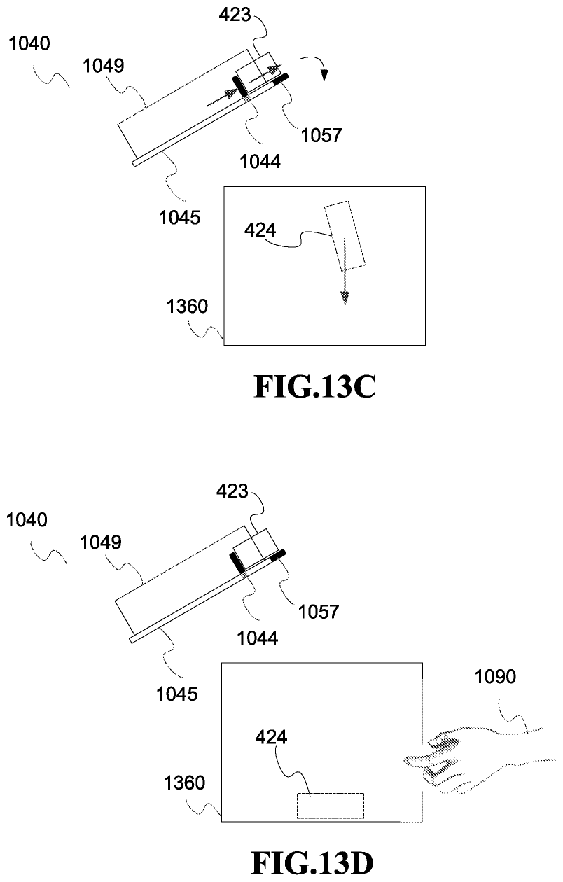

FIG. 13A shows a simplified side view, along the longitudinal axis, of the product picking module of the sixth exemplary embodiment, after it has been positioned over the dispensing area. Loading platform 1045 is moved for its product picking member 1057 to be positioned over product dispensing area 1360. Product loading platform 1045 holds, in the present example, first 423 and second 424 products. An internal may be fitted on the upper side of product dispensing area 1360, which if not already open, it is opened now.

FIG. 13B shows a simplified side view, along the longitudinal axis, of the product picking module of the sixth exemplary embodiment, after it has been positioned over the dispensing area, and while the product unloading member pushes the loaded products off the product loading platform. Product unloading member 1044 pushes the loaded first 423 and second 424 products towards product picking member 1057 and off product loading platform's 1045.

FIG. 13C shows a simplified side view, along the longitudinal axis, of the product picking module of the sixth exemplary embodiment, after its product unloading member has pushed the second loaded product off the product loading platform. Product unloading member 1044 stops pushing the loaded first product 423 when second product 424 has toppled and dropped off product loading platform's 1045, towards product dispensing area 1360.

FIG. 13D shows a simplified side view, along the longitudinal axis, of the product picking module of the sixth exemplary embodiment, after the second loaded product is being picked up by the customer from inside the dispensing area. Second product 424 has landed on the bottom of product dispensing area 1360. The internal door of dispensing area 1360 is closed and then an external door that may be fitted to the outside face (right face in the illustrated example) of dispensing area 1360 is opened, thereby giving access to the interior of dispensing area 1360 to the customer. The customer can then grab second product 424 with his hand 1090.

The same process illustrated in FIG. 13A-D is applicable to discarding products (e.g. expired products), and where dispensing area 1360 is replaced by a disposal area.

Both dispensing area 1360 and disposal area may have their opening (and optional internal door) at their upper side or to their inner side (i.e. left side in the illustrated example). In the first case, dispensing or discarding is done as shown in FIG. 13A-D. In the second case, product picking module 1040 partially or fully inserted in the dispensing area 1360 or disposal area from the respective inner opening (the left side opening) and then unloads the product to be dispensed or disposed.

During the above operations, the vending matching tracks and logs the position and movement of products, their dimensions, and relative positions in stacks, using sensors, so as to ensure that only the desired products will be dispensed and/or disposed and that their order in the product stacks remains known.

The exemplary embodiments of FIG. 9-13 operate according to the exemplary methodology presented in the high-level flow diagram of FIG. 6. Alignment of the product loading platform with the sub-shelves, dispenser area, and disposal area, and the relative movement of product picking module 1057 and product unloading member 1044 in steps 625, 635, 690, 685, 665 are performed according to the description presented for FIG. 11-13. The sixth exemplary embodiment and its variations are implemented using the electronics and software architectures of FIG. 7-8.

The above exemplary embodiments are presented for use in automatic vending machines. However, they may also be used in any other product handling system without departing from the scope of protection of the invention.

The above exemplary embodiment descriptions are simplified and do not include hardware and software elements that are used in the embodiments but are not part of the current invention, or are not needed for the understanding of the embodiments, or are obvious to any user of ordinary skill in related art. Furthermore, variations of the described system architecture are possible, where, for instance, some servers may be omitted or others added.

The figures and the electro-mechanical and electronic components they illustrate are not necessarily in scale, and their relative positions and interconnections are exemplary. Their variations, which are obvious to persons of skill in related art, are within the scope of protection of the present innovative solution.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

The foregoing description of a preferred embodiment and best mode of the invention known to the applicant at the time of filing the application has been presented and is intended for the purposes of illustration and description. It is not intended to be exhaustive or limit the invention to the precise form disclosed and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out this invention, but that the invention will include all embodiments falling within the scope of the appended claims.

In one or more exemplary embodiments, the functions described may be implemented in hardware, software, firmware, or any combination thereof. If implemented in software, the functions may be stored on or transmitted over as one or more instructions or code on a computer readable medium. Computer-readable media includes both computer storage media and communication media including any medium that facilitates transfer of a computer program from one place to another. A storage medium may be any available medium that can be accessed by a computer or computing apparatus. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for selecting a product from any position in a stack of products for increasing the capacity of different product types in an automatic vending machine, comprising:
a modular storage module, comprising at least one reconfigurable inclined shelf and a plurality of shelf partitions jointly forming at least one inclined sub-shelf in each of the at least one shelf, wherein each of the at least one sub-shelf (a) comprises a product stop member attached at a lowest end of the sub-shelf, (b) comprises a gap running from the lowest end to a highest end of the sub-shelf, (c) the sub-shelf being configured for holding the stack of products, and (d) the product stop member is configured for a first product in the stack of products to be in contact with the product stop member;
a movable product picking module comprising (e) a main body, (f) a longitudinal gap between two ends of the product picking module, (g) a first product picking member attached at one of the two ends of the main body and aligned with the longitudinal gap, and (h) means for unloading products from the product picking module;
a positioning module;
a dispenser module; and
a control module electrically connected to at least the product picking module and the positioning module and configured for controlling the product picking module and the positioning module by (i) actuating the positioning module to move the product picking module so that the first product picking member is positioned under the first product and aligned with the gap of the sub-shelf, (ii) raising the first product picking member through the gap of the sub-shelf for pushing the first product to overcome the product stop member and topple from the stack onto the main body and facilitating the first product to load on the main body, (iii) lowering the first product picking member under the main body of the sub-shelf for allowing at least a second product in the stack to slide downhill the sub-shelf until it touches the product stop member, (iv) repeating steps (i)-(iii) to move the at least second product from the stack to the main body while maintaining a relative order of the first product and the at least second product, (iv) repositioning the product picking module, (v) actuating the means for unloading products to move a last loaded on the main body of the at least second product onto one of another sub-shelf, the dispenser module, and a discard module, (vi) repositioning the product picking module so that the first product picking member is positioned in front of a third product in the stack of the sub-shelf and above the product stop member, and aligned with the gap of the sub-shelf, (vii) actuating the means for unloading products to move all products from the main body to the stack of the sub-shelf by pushing the third product away from the product stop member, (viii) retracting the first product picking member for allowing all products on the stack to slide until the first product touches the product stop member, and (ix) updating a product log.

2. The system of claim 1, further comprising:
a second product picking member attached at an opposite end to the one of the two ends of the main body and aligned with the longitudinal gap;
a first actuator connected to the first product picking member;
a second actuator connected to the second product picking member;
a conveyor module attached onto the main body and configured for facilitating loading products from the sub-shelf to the main body and for unloading products from the main body by rotating in opposite directions, respectively;
wherein:
the product picking module, the main body, and conveyor module are arranged horizontally;
the first and the second product picking members are rotatably attached to the main body;
the first and the second product picking members are configured to rotate between a disengaged position entirely under the sub-shelf and an engaged position partially extending though the gap of the sub-shelf and pushing upwards a product resting on the product stop member to overcome the product stop member; and
the means for unloading products from the product picking module is the conveyor module.

3. The system of claim 1, further comprising:
a product unloading member connected to the product picking module, extending through the longitudinal gap and protruding above the top surface of the main body, and being configured to move along the longitudinal gap for pushing products off the product picking module; and
a first actuator connected to the product unloading member;
wherein:
the product picking module and the main body are arranged at about an inclination of the sub-shelf;
the first product picking member is non-movably attached to the main body at about the same level as the top of the main body;
the means for unloading products from the product picking module is the product unloading member; and
in step (ii) the first product is facilitated to load on the main body by sliding downhill the main body until the first product touches the product unloading member.

4. The system of claim 1, wherein the product picking module further comprises two barrier members, each attached to one of two sides lying along a traverse axis of the main body.

5. The system of claim 1, wherein at least one product type is stacked in any sub-shelf.

6. The system of claim 1, wherein the different product types have a plurality of dimensions and lie on any side.

7. The system of claim 1, further comprising:
a plurality of actuators configured for moving the product picking module; and
a plurality of sensors configured for detecting at least one of (x) at least one position of any of the product picking module, the first product picking member, and the second product picking member, and (xi) at least one product.

8. The system of claim 1, further comprising:
a plurality of actuators configured for moving the product picking module; and
a plurality of sensors configured for detecting at least one of (xii) at least one position of any of the product picking module, and the product unloading member, and (xiii) at least one product.

9. A method, controlled by a control module, for selecting a product from any position in a stack of products on an inclined sub-shelf for increasing the capacity of different product types in an automatic vending machine, the method comprising:
actuating a positioning module to move a product picking module so that a first product picking member of the product picking module is positioned under a first product and aligned with a gap running from a lowest end to a highest end of the sub-shelf;
raising the first product picking member through the gap of the sub-shelf for pushing the first product to overcome a product stop member, attached at the lower end of the sub-shelf, and topple from the stack onto a main body of the product picking module;
facilitating the first product to load on the main body;
lowering the first product picking member under the sub-shelf for allowing at least a second product in the stack to slide until it touches the product stop member;
repeating previous actuating, raising, and facilitating steps for moving the at least second product from the stack to the main body while maintaining a relative order of the first product and the at least one second product;
repositioning the product picking module;
actuating means for unloading products to move a last loaded on the main body of the at least second product onto one of another sub-shelf, a dispenser module, and a discard module;
repositioning the product picking module so that the first product picking member is positioned in front of a third product in the stack of the sub-shelf and above the product stop member, and aligned with the gap of the sub-shelf;
actuating the means for unloading products to move all products from the main body to the stack of the sub-shelf by pushing the third product away from the product stop member;
retracting the first product picking member for allowing all products on the stack to slide until the first product touches the product stop member; and
updating a product log.

10. The method of claim 9, further comprising:
facilitating loading products from the sub-shelf onto the main body and unloading products from the main body using a conveyor module attached onto the main body and rotating in opposite directions, respectively;
wherein:
a second product picking member is attached at an opposite end to the one of the two ends of the main body and aligned with the longitudinal gap;
the product picking module and the main body are arranged horizontally;
the first and the second product picking members are rotatably attached to the main body;
the first and the second product picking members are configured to rotate between a disengaged position entirely under the sub-shelf and an engaged position partially extending though the gap of the sub-shelf and pushing upwards a product resting on the product stop member to overcome the product stop member; and
the means for unloading products from the product picking module is the conveyor module.

11. The method of claim 9, further comprising:
unloading the product picking module by pushing products off the product picking module by moving a product unloading member along the longitudinal gap, which is connected to the product picking module, extends through the longitudinal gap and protrudes above the top surface of the main body; and
facilitating the first product to load on the main body by sliding the first product downhill the main body until the first product touches the product unloading member;
wherein:
the product picking module and the main body are arranged at about an inclination of the sub-shelf;
the first product picking member is non-movably attached to the main body; and
the means for unloading products from the product picking module is the product unloading member.

12. The method of claim 9, wherein at least one product type is stacked in any sub-shelf.

13. The method of claim 9, wherein:
the different product types have a plurality of dimensions; and
the different product types lie on any side.

14. The method of claim 9, further comprising:
moving the product picking module with a plurality of actuators; and
detecting at least one of (x) at least one position of any of the product picking module, the first product picking member, and the second product picking member, and (xi) at least one product, using at least one sensor.

15. A non-transitory computer program product that causes a controller module to select a product from any position in a stack of products on an inclined sub-shelf for increasing the capacity of different product types in an automatic vending machine, the computer program product comprising instructions to cause the controller module to:
actuate a positioning module to move a product picking module so that a first product picking member of the product picking module is positioned under a first product and aligned with a gap running from a lowest end to a highest end of the sub-shelf;
raise the first product picking member through the gap of the sub-shelf for pushing the first product to overcome a product stop member, attached at the lower end of the sub-shelf, and topple from the stack onto a main body of the product picking module;
facilitate the first product to load on the main body;
lower the first product picking member under the sub-shelf for allowing at least a second product in the stack to slide until it touches the product stop member;
repeat previous actuating, raising, and facilitating steps for moving the at least second product from the stack to the main body while maintaining a relative order of the first product and the at least second product;
reposition the product picking module;
actuate means for unloading products to move a last loaded on the main body of the at least second product onto one of another sub-shelf, a dispenser module, and a discard module;
reposition the product picking module so that the first product picking member is positioned in front of a third product in the stack of the sub-shelf and above the product stop member, and aligned with the gap of the sub-shelf;
actuate the means for unloading products to move all products from the main body to the stack of the sub-shelf by pushing the third product away from the product stop member;
retract the first product picking member for allowing all products on the stack to slide until the first product touches the product stop member; and
update a product log.

16. The non-transitory computer program product of claim 15, further comprising instructions to cause the controller module to:
facilitate loading products from the sub-shelf to the main body and unloading products from the main body using a conveyor module attached onto the main body and rotating in opposite directions, respectively;
wherein:
a second product picking member is attached at an opposite end to the one of the two ends of the main body and aligned with the longitudinal gap;
the product picking module and the main body are arranged horizontally;
the first and the second product picking members are rotatably attached to the main body;
the first and the second product picking members are configured to rotate between a disengaged position entirely under the sub-shelf and an engaged position partially extending though the gap of the sub-shelf and pushing upwards a product resting on the product stop member to overcome the product stop member; and
the means for unloading products from the product picking module is the conveyor module.

17. The non-transitory computer program product of claim 15, further comprising instructions to cause the controller module to:
unloading the product picking module by pushing products off the product picking module by moving a product unloading member along the longitudinal gap, which is connected to the product picking module, extends through the longitudinal gap and protrudes above the top surface of the main body; and
facilitate the first product to load on the main body by sliding the first product downhill the main body until the first product touches the product unloading member.
wherein:
the product picking module and the main body are arranged at about an inclination of the sub-shelf;
the first product picking member is non-movably attached to the main body; and
the means for unloading products from the product picking module is the product unloading member.

18. The non-transitory computer program product of claim 15, wherein at least one product type is stacked in any sub-shelf.

19. The non-transitory computer program product of claim 15, wherein:
the different product types have a plurality of dimensions; and
the product types lie on any side.

20. The non-transitory computer program product of claim 15, further comprising:
moving the product picking module with a plurality of actuators; and
detecting at least one of (x) at least one position of any of the product picking module, the first product picking member, and the second product picking member, and (xi) at least one product, using at least one sensor.
